(19) United States
(12) Patent Application Publication
(10) Pub. No.: US 2017/0059952 A1
(43) Pub. Date: Mar. 2, 2017

(54) DISPLAY DEVICE

(71) Applicant: Japan Display Inc., Minato-ku (JP)

(72) Inventors: Osamu ITOU, Tokyo (JP); Yoshiro AOKI, Tokyo (JP)

(73) Assignee: Japan Display Inc., Minato-ku (JP)

(21) Appl. No.: 15/230,943

(22) Filed: Aug. 8, 2016

(30) Foreign Application Priority Data
Aug. 27, 2015 (JP) 2015-168085

(51) Int. Cl. G02F 1/1362; G02F 1/1343; G02F 1/1368; G02F 1/1339

(52) U.S. Cl. CPC G02F 1/136209; G02F 1/136286; G02F 1/13394; G02F 1/134309; G02F 1/1368; G02F 2001/136222; G02F 2001/134345; G02F 2201/121; G02F 2201/123; G02F 1/1337

(57) ABSTRACT

According to one embodiment, a liquid crystal display device includes a first substrate including a scan signal line, an image signal line, a thin-film transistor, and a color filter including a recessed portion which is recessed in planar view, a second substrate above the first substrate, a liquid crystal layer between the first substrate and the second substrate, and a spacer, wherein the spacer and the scan signal line are provided in the recessed portion in planer view.

### CROSS-REFERENCE TO RELATED APPLICATIONS

This application is based upon and claims the benefit of priority from Japanese Patent Application No. 2015-168085, filed Aug. 27, 2015, the entire contents of which are incorporated herein by reference.

### FIELD

Embodiments described herein relate generally to a liquid crystal display device.

### BACKGROUND

In manufacturing a liquid crystal display device comprising upper and lower substrates via liquid crystal, wherein the upper substrate includes a color filter and a black matrix and the lower substrate includes an interconnect and a thin-film transistor, alignment is extremely difficult and thus color mixing and aperture ratio reduction tend to occur. To solve these problems, a color-filter-on-array (COA) method of forming a color filter and a thin-film transistor element on the same substrate is used. For example, there is a COA liquid crystal display device comprising a color filter which is arranged such that the outer edge of the color filter is provided along a signal line.

### BRIEF DESCRIPTION OF THE DRAWINGS

FIG. 1 is an overall perspective view of a liquid crystal display device.

FIG. 2 is an overall perspective view of a thin-film transistor substrate.

FIG. 3 is a plan view of the thin-film transistor substrate.

FIG. 4 is a sectional view of the liquid crystal display device.

FIG. 5 is a sectional view of the liquid crystal display device.

FIG. 6 is a plan view of a thin-film transistor substrate.

FIG. 7 is a plan view of the thin-film transistor substrate for showing the shape of a color filter.

FIG. 8 is a plan view of the thin-film transistor substrate for explaining dimensions.

FIG. 9 is a plan view of the thin-film transistor substrate for showing the shape of a color filter.

FIG. 10 is a sectional view of a liquid crystal display device.

FIG. 11 is a sectional view of a liquid crystal display device.

FIG. 12 is a plan view of a thin-film transistor substrate for showing the shape of a color filter.

FIG. 13 is a sectional view of the liquid crystal display device.

FIG. 14 is a plan view of the thin-film transistor substrate for explaining dimensions.

FIG. 15 is a sectional view of a liquid crystal display device.

FIG. 16 is a sectional view of the liquid crystal display device.

FIG. 17 is a sectional view of the liquid crystal display device.

FIG. 18 is a sectional view of the liquid crystal display device.

FIG. 19 is a sectional view of a liquid crystal display device.

FIG. 20 is a sectional view of a liquid crystal display device.

FIG. 21 is a sectional view of the liquid crystal display device.

FIG. 22 is a sectional view of the liquid crystal display device.

FIG. 23 is a sectional view of a liquid crystal display device.

FIG. 24 is a sectional view of a liquid crystal display device.

FIG. 25 is a sectional view of the liquid crystal display device.

FIG. 26 is a sectional view of a liquid crystal display device.

FIG. 27 is a sectional view of a liquid crystal display device.

FIG. 28 is a sectional view of the liquid crystal display device.

FIG. 29 is a sectional view of the liquid crystal display device.

FIG. 30 is a sectional view of a liquid crystal display device.

FIG. 31 is a sectional view of the liquid crystal display device.

FIG. 32 is a plan view of a liquid crystal display device for showing the positions of a first spacer and a second spacer.

FIG. 33 is a sectional view of the liquid crystal display device.

FIG. 34 is a sectional view of the liquid crystal display device.

FIG. 35 is a sectional view of the liquid crystal display device.

FIG. 36 is a sectional view of a liquid crystal display device.

FIG. 37 is a plan view of the liquid crystal display device for showing the positions of a color filter, the first spacer and the second spacer.

FIG. 38 is a plan view of a liquid crystal display device for showing the positions of a color filter, a first spacer and a second spacer.

FIG. 39 is a plan view of a liquid crystal display device for showing the positions of a first spacer and a second spacer.

FIG. 40 is a sectional view of the liquid crystal display device.

FIG. 41 is a plan view of the liquid crystal display device for showing the positions of a first spacer and a second spacer.

FIG. 42 is a sectional view of the liquid crystal display device.

### DETAILED DESCRIPTION

In general, according to one embodiment, a liquid crystal display device comprises: a first substrate including a scan signal line, an image signal line, a thin-film transistor, and a color filter including a recessed portion which is recessed in planar view; a second substrate above the first substrate; a liquid crystal layer between the first substrate and the second substrate; and a spacer, wherein the spacer and the scan signal line are provided in the recessed portion in planar view.

According to another embodiment, a liquid crystal display device comprises: a first substrate comprising a scan signal line, an image signal line, a thin-film transistor, and a color filter including a recessed portion which is recessed in planar view; a second substrate above the first substrate; a liquid crystal layer between the first substrate and the second substrate; and a spacer, wherein an intersection of the scan signal line and the image signal line is provided in the recessed portion in planar view.

According to yet another embodiment, a liquid crystal display device comprises: a first substrate including a scan signal line, an image signal line, a thin-film transistor, a plurality of color filters; a second substrate above the first substrate; a liquid crystal layer between the first substrate and the second substrate; and a spacer, wherein some of the color filters are narrower than the others of the color filters, and the narrower color filters are provided along the scan signal lines.

### First Embodiment

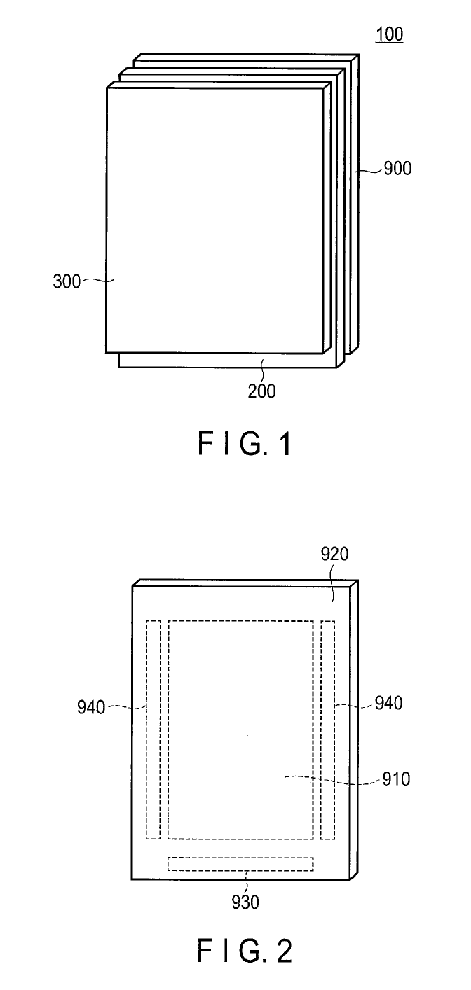

The first embodiment will be described below. FIG. 1 is an overall perspective view of a liquid crystal display device 100. The liquid crystal display device 100 comprises a thin-film transistor substrate 200 as a first substrate, a countersubstrate 300 as a second substrate, and a backlight unit 900.

The thin-film transistor substrate 200 and the countersubstrate 300 will be described later.

The backlight unit 900 comprises a light emitting element such as a light emitting diode (LED) and emits light to transmit light through the thin-film transistor substrate 200 and the countersubstrate 300 from the outside of the thin-film transistor substrate 200.

FIG. 2 is an overall perspective view of the thin-film transistor substrate 200. The thin-film transistor substrate 200 comprises a display area 910 and a non-display area 920. Further, the thin-film transistor substrate 200 comprises a connection terminal 930 and a drive circuit 940. Still further, the display area 910 is located in the center of a surface which is opposed to the countersubstrate 300.

The display area 910 is an area where an image is displayed. The display area 910 is located in the center of the thin-film transistor substrate 200. The display area 910 comprises a plurality of pixels and displays an image based on an input scan signal and an input image signal. Here, the pixel is the smallest unit of full-color information, and in the present embodiment, the pixel includes one subpixel for red information, one subpixel for blue information and one subpixel for green information.

The non-display area 920 is an area where no image is displayed. The non-display area 920 is located on the outside of the display area 910.

The connection terminal 930 is a terminal for connecting a device external to the liquid crystal display device 100. The connection terminal 930 is provided in the non-display area 920. The connection terminal 930 inputs signals necessary for image display, namely, a clock signal and an image signal from an external device.

The drive circuit 940 is provided in the periphery of the thin-film transistor substrate 200. The drive circuit 940 is provided in the non-display area 920. The drive circuit 940 may be a single circuit or a plurality of circuits. The drive circuit 940 controls the output of an input scan signal. The drive circuit 940 may control the output of an input image signal.

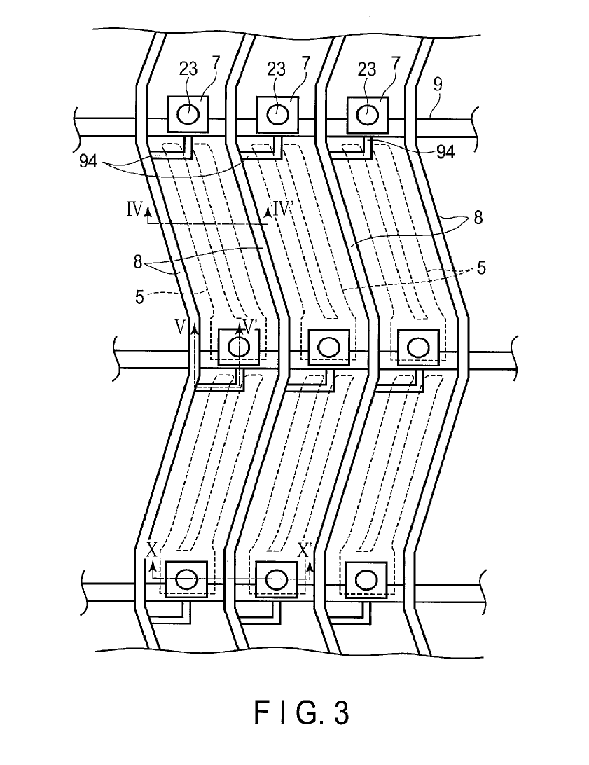

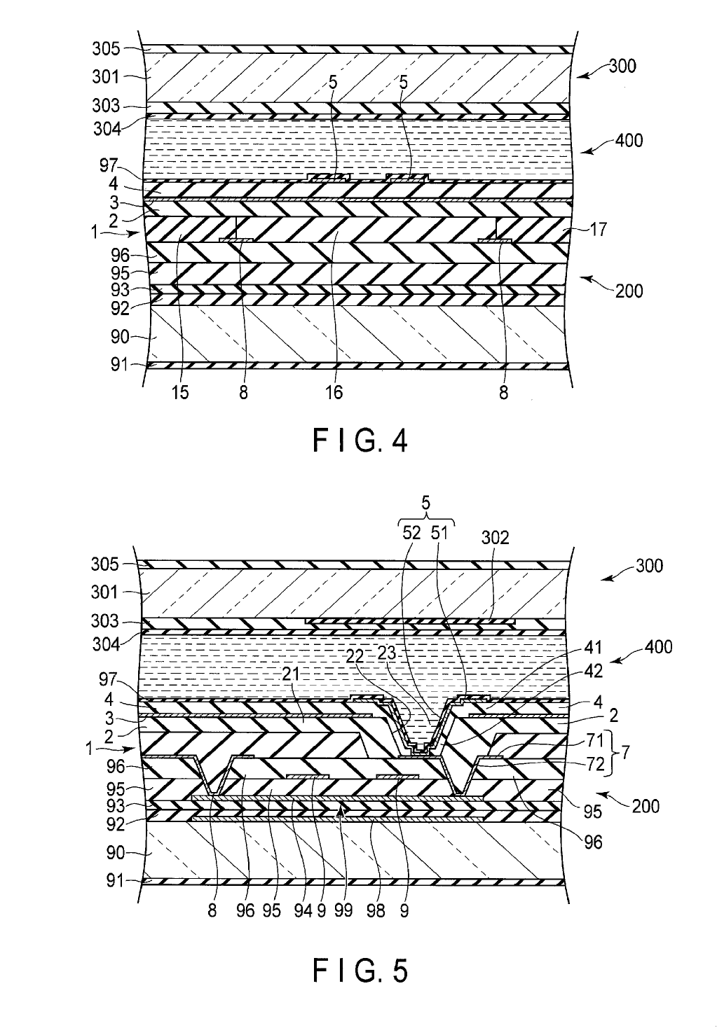

FIG. 3 is a plan view of the thin-film transistor substrate 200. FIG. 4 is a sectional view of the liquid crystal display device 100. FIG. 5 is a sectional view of the liquid crystal display device 100. FIGS. 3 to 5 show some pixels in the display area 910 of the liquid crystal display device 100. FIG. 4 is a sectional view along line IV-IV′ of FIG. 3. Further, FIG. 5 is a sectional view along line V-V′ of FIG. 3.

In each embodiment, the direction from the thin-film transistor substrate 200 to the countersubstrate 300 is assumed to be the upper direction, and the direction from the countersubstrate 300 to the thin-film transistor substrate 200 is assumed to be the lower direction.

The liquid crystal display device 100 further comprises a liquid crystal layer 400 provided above the thin-film transistor substrate 200 and below the countersubstrate 300.

The thin-film transistor substrate 200 comprises, a color filter 1, a second insulating layer 2, a common electrode 3 as one of a first electrode and a second electrode, a first insulating layer 4, a pixel electrode 5 as the other of the first electrode and the second electrode, a source electrode 7, an image signal line 8 as a signal line, a drain electrode 81, a scan signal line 9 as a signal line, a transparent substrate 90, a first polarizer 91, an undercoat film 92, an undercoat film 93, a semiconductor layer 94, an insulating layer 95, an insulating layer 96, a first alignment film 97, and a thin-film transistor light-blocking layer 98.

The transparent substrate 90 has the shape of a flat plate. The transparent substrate 90 has, for example, a thickness of 200 μm. Note that the numerical value of the thickness, the size or the like described in the present embodiment is a mere example but may be used as a reference for the magnitude relationship of one portion to another portion. The transparent substrate 90 is glass such as borosilicate glass but may be, for example, resin such as plastic.

The first polarizer 91 is provided below the transparent substrate 90 and is in contact with the transparent substrate 90.

The undercoat film 92 is provided above the transparent substrate 90 and is in contact with the transparent substrate 90. The undercoat film 92 has a thickness of 100 nm. The undercoat film 92 is formed of an insulating material such as silicon nitride.

The undercoat film 93 is provided above the undercoat film 92 and is in contact with the undercoat film 92. The undercoat film 93 has a thickness of 100 nm. The undercoat film 93 is formed of an insulating material such as silicon oxide.

The semiconductor layer 94 is provided partly above the undercoat film 93 and is in contact with the undercoat film 93. The semiconductor layer 94 has a meandering strap-like shape in planer view. The semiconductor layer 94 is, for example, polysilicon, which is obtained from amorphous silicon through a laser annealing treatment. Further, the semiconductor layer 94 may be, for example, amorphous silicon or may be an oxide semiconductor containing indium, gallium, zinc or the like.

The insulating layer 95 has the shape of a flat plate. The insulating layer 95 is continuously provided above the semiconductor 94 and above the undercoat film 93 where the semiconductor layer 94 is not provided. The insulating layer 95 is in contact with the undercoat film 93 and with the semiconductor layer 94. The insulating layer 95 is, for example, silicon nitride. Further, the insulating layer 95 comprises two holes for each subpixel. Each hole is formed in a part of the insulating layer 95 above the semiconductor layer 94. The hole is a vertical through-hole and is tapered downward.

The scan signal line 9 is a straight line extending in a predetermined direction in planar view. The scan signal line 9 is, for example, a molybdenum tungsten alloy. Note that the scan signal line 9 may be another conductive metal such as a titanium aluminum alloy. The scan signal line 9 has a thickness of 200 nm. The scan signal line 9 is provided above the insulating layer 95 and is located at the boundary of the subpixels. The scan signal line 9 is in contact with the insulating layer 95. The scan signal lines 9 are provided at regular intervals. Further, the scan signal line 9 may be partly meandering. The distance between the adjacent scan signal lines 9 is 53.7 μm.

The insulating layer 96 has the shape of a flat plate. The insulating layer 96 is, for example, silicon nitride. The insulating layer 96 is continuously provided above the scan signal line 9 and above the insulating layer 95 where the scan signal line 9 is not provided. The insulating layer 96 is in contact with the insulating layer 95 and the scan signal line 9.

Further, the insulating layer 96 comprises two holes for each subpixel which vertically penetrate the insulating layer 96 and are tapered downward. The two holes formed in the insulating layer 96 are located above the two holes formed in the insulating layer 95. Therefore, the holes of the insulating layer 95 communicate respectively with the holes of the insulating layer 96. Each hole is formed in a part of the insulating layer 96 above the semiconductor layer 94. The hole is a vertical thorough-hole and is tapered downward. The two holes of the insulating layer 96 may be formed such that the shape of the lower edge of each hole of the insulating layer 96 conforms to the shape of the upper edge of each hole of the insulating layer 95.

The thin-film transistor light-blocking layer 98 is provided below the semiconductor layer 94. The thin-film transistor light-blocking layer 98 overlaps the semiconductor layer 94 in planar view. The thin-film transistor light-blocking layer 98 may be in contact with the transparent substrate 90. The thin-film transistor light-blocking layer 98 is formed of a light-blocking material such as molybdenum tungsten and has a thickness of, for example, about 100 nm.

The source electrode 7 comprises a flat plate portion 71 and a connection portion 72. The flat plate portion 71 is provided above the insulating layer 96. The flat plate portion 71 is a plate smaller than an area defined by the adjacent scan signal lines 9 and the adjacent image signal lines 8 along the boundary of the subpixels, and for example, the flat plate portion 71 is rectangular in planar view. The source electrode 7 is, for example, metal containing titanium, aluminum and titanium stacked in this order. Each of the two titanium layers has a thickness of 100 nm, and the aluminum layer has a thickness of 450 nm.

Further, the connection portion 72 is located in about the center of the flat plate portion 71 and is integrally formed with the flat plate portion 71. The connection portion 72 is, for example, conical or truncated conical, and projects downward. The connection portion 72 is tapered downward. In the connection portion 72, the side surface is provided in the hole of the insulating layer 96 and in the hole of the insulating layer 95, and the lower edge is in contact with the upper surface of the semiconductor layer 94.

The image signal line 8 is provided above the insulating layer 96. The image signal line 8 is metal containing titanium, aluminum and titanium stacked in this order. Each of the two titanium layers has a thickness of 100 nm, and the aluminum layer has a thickness of 450 nm. Note that the image signal line 8 may be another conductive metal such as molybdenum tungsten. The image signal line 8 is generally perpendicular to the scan signal line 9 in planer view. However, in each pixel, that is, between two adjacent scan signal lines 9, the image signal line 8 extends in a direction neither perpendicular nor parallel to the scan signal line 9. The distance between the adjacent scan signal lines 8 is 17.9 μm.

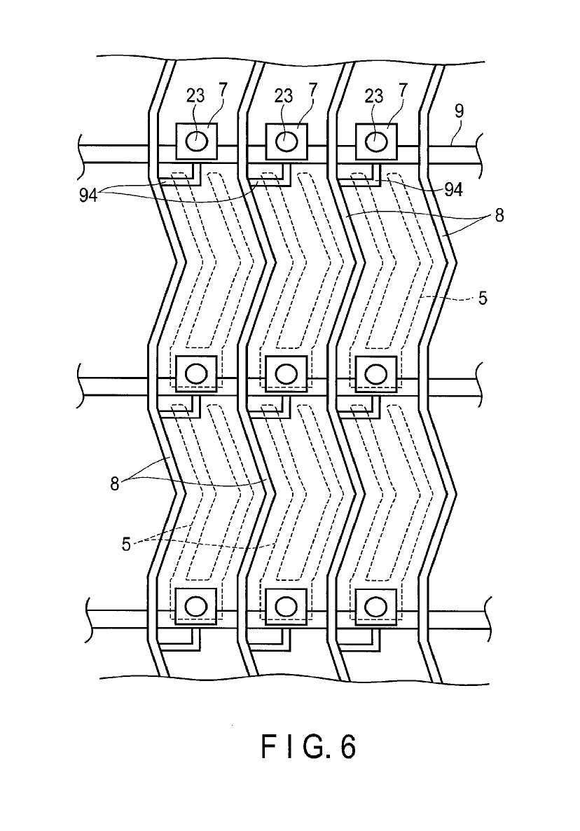

FIG. 6 is a plan view of the thin-film transistor substrate 200. In each pixel, the image signal line 8 may be straight or may be at least partly meandering.

The image signal lines 8 are arranged side by side in the direction along the scan signal lines 9 and are meandering in the same manner as each other. Further, in the direction perpendicular to the scan signal lines 9, the image signal lines 8 extend symmetrically with respect to the scan signal lines 9. That is, the image signal line 8 alternately bends in opposite directions as the image signal line 8 crosses the scan signal lines 9.

The drain electrode 81 is connected to the image signal line 8. The drain electrode 81 is provided in the vicinity of the source electrode 7. The drain electrode 81 is, for example, conical or truncated conical, and projects downward. The drain electrode 81 is tapered downward. In the drain electrode 81, the side surface is provided in the hole of the insulating layer 96 and in the hole of the insulating layer 95, and the lower edge is in contact with the upper surface of the semiconductor layer 94. The drain electrode 81 may be formed integrally with the image signal line 8 or may be formed separately from the image signal line 8.

In this structure, the flat plate portion 71 of the source electrode 7 is provided in the same layer as the image signal line 8, and the source electrode 7 and the drain electrode 81 are in contact with the same semiconductor layer 94. Note that the source electrode 7 and the drain electrode 81 may be provided in the same layer.

A thin-film transistor 99 comprises the semiconductor layer 94, the source electrode 7, the drain electrode 81, the scan signal line 9, and a part of the insulating layer 95. A part of the scan signal line 9 functions as an electrode which transmits a scan signal. That is, a part of the scan signal line 9 corresponds to a gate electrode of the thin-film transistor 99. The scan signal line 9 is electrically connected to the electrodes constituting the thin-film transistor 99. The boundary between the image signal line 8 and the drain electrode 81 is the same as the boundary of the adjacent thin-film transistors 99.

Now, the operation of the thin-film transistor 99 will be described below. The scan signal line 9 is connected to the drive circuit 940. The scan signal line 9 transmits a scan signal generated from a clock signal and a start pulse signal which are input from the drive circuit 940. The scan signal has a gate high voltage when the thin-film transistor 99 is conducting and has a gate low voltage when the thin-film transistor 99 is non-conducting, which will be described later. The image signal line 8 transmits an image signal which is input from the connection terminal 930. The image signal has a voltage according to the luminance of a display image, and the voltage may be a direct-current voltage or may be an alternating-current voltage exhibiting polarity inversion.

When conducting, the thin-film transistor 99 transmits a potential corresponding to an image signal which is input from the image signal line 8 to the source electrode 7 and the pixel electrode 5 via the semiconductor layer 94, which will be described later.

Note that the thin-film transistor 99 does not necessarily have the above-described structure. For example, the scan signal line 9 constituting the thin-film transistor 99 may be provided in a level lower than the semiconductor layer 94 or may be provided in the same level as the semiconductor layer 94.

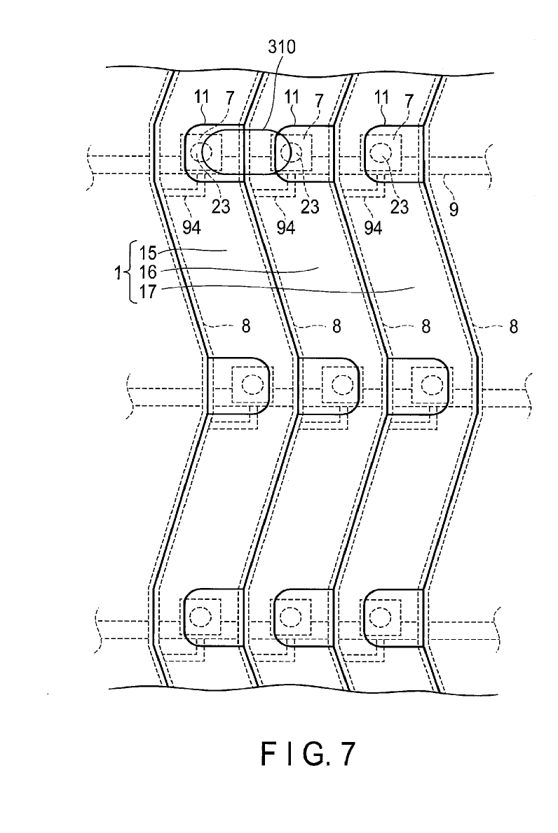

FIG. 7 is a plan view of the thin-film transistor substrate 200 for showing the shape of the color filter 1. The color filter 1 is continuously provided above the source electrode 7, the image signal line 8 and the insulating layer 96 where the source electrode 7 and the image signal line 8 are not provided. The color filter 1 is in contact with the source electrode 7, the image signal line 8, and the insulating layer 96. The color filter 1 is formed of an insulating material, more specifically, an organic negative photoresist containing a colored material such as a pigment or a dye. The color filter 1 has a thickness of 1 to 3 μm.

The color filter 1 is any one of a red filter 15, a green filter 16 and a blue filter 17. Any one of the red filter 15, the green filter 16 and the blue filter 17 is provided in each subpixel, and the cycle of these color filters is repeated along the scan signal lines 9. A red subpixel comprises the red color filter 15. A green subpixel comprises the green color filter 16. A blue subpixel comprises the blue color filter 17. Note that the color filter 1 of the present embodiment may further include various other color filters.

In the liquid crystal display device 100 of the present embodiment, a set of the red subpixel, the green subpixel and the blue subpixel is assumed to be a single pixel. The pixels are arranged along the image signal lines 8 and along the scan signal lines 9.

Each color filter 1 has a strap-like shape and extends along the video signal line 8. Further, each color filter 1 is continuously provided above the scan signal lines 9. That is, a single color filter 1 is used for a plurality of subpixels. It is preferable that a single color filter 1 should be continuously provided across three or more scan signal lines 9.

Further, at the two edges of the color filter 1 along the image signal line 8, one edge thoroughly extends along the image signal line 8. In the present embodiment, an edge of the blue filter 17 at the green filter 16 side thoroughly extends along the image signal line 8. Further, in the blue filter 17, it is preferable that an edge at the green filter 16 side thoroughly overlaps the green filter 16.

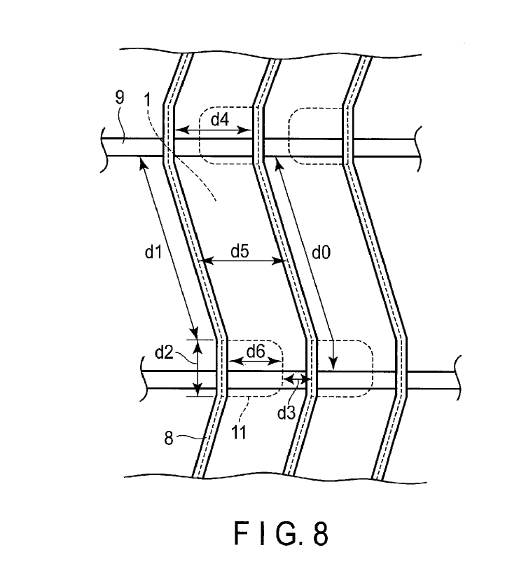

FIG. 8 is a plan view of the thin-film transistor substrate 200 for explaining dimensions. Further, at the other edge of the color filter 1, a part of the edge includes a center portion between the adjacent scan signal lines 9 and extends along the image signal line 8. It is preferable that this part of the edge along the image signal line 8 has a length greater than or equal to a half of a length d0 of the image signal line 8 between the adjacent scan signal lines 9. Further, it is also preferable that the two adjacent color filters 1 overlap each other in this part of the edge along the image signal line 8.

Still further, the other edge of the color filter 1 includes a recessed portion 11 which is recessed in the direction along the scan signal line 9. In the present embodiment, an edge of the green filter 16 at the red filter 15 side comprises one part including the center portion extending along the video signal line 8 and the other part including the recessed portion 11.

The recessed portion 11 is a vertical thorough-hole, and the color filter 1 is not provided in the recessed portion 11. The recessed portion 11 has a curved periphery, and both ends of the periphery coincide with the one part of the other edge of the color filter 1 extending along the image signal line 8. A part of the periphery of the recessed portion 11 is provided above the scan signal line 9. In planar view, a part of the image signal line 8 and a part of the scan signal line 9 are provided in the recessed portion 11. Further, in planar view, at least a part of the intersection of the image signal line 8 and the scan signal line 9 is provided in the recessed portion 11.

A width 2 of the recessed portion 11 along the image signal line 8 is less than a length d1 of the one part of the other edge of the color filter extending along the image signal line 8. Further, the width 2 of the recessed portion 11 along the image signal line 8 should preferably be 10% or more to 30% or less of a length d0 of the image signal line 8 between the adjacent scan signal lines 9.

A part of the color filter 1 where the recessed portion 11 is provided is narrower the other part of the color filter 1. The narrow portion of the color filter 1 is provided along the scan signal line 9.

In the recessed portion 11, the recess gradually becomes smaller toward the bottom, and the side surface is inclined. For example, the periphery of the recessed portion 11 has a partial arc shape, the upper edge of which has a diameter of 10 μm and the lower edge of which has a diameter of 8 μm. Further, the recessed portion 11 is provided above a part of the scan signal line 9. Note that the recessed portion 11 is not limited to any particular shape and may be another shape such as ellipsoidal or the like in planar view. The bottom of the recessed portion 11 is provided at a distance from the image signal line 8 in planar view.

The narrowest portion of the color filter 1 has a width d3 and also indicates a position where the bottom of the recessed portion 11 is located. It is preferable that the width d3 of the color filter 1 from the recessed portion 11 to the image signal line 8 should be 40% or less, more desirably, 30% or less of a distance d4 between the adjacent image signal lines 8. Further, it is preferable that the width d2 of the recessed portion 11 along the image signal line 8 should be 10% or more, more desirably, 20% or more of the distance d4 between the adjacent image signal lines 8.

In this way, for example, the other part of the other edge of the green filter 16 overlap the red filter 15 or the blue filter 17. Further, at least the one part of the other edge including the recessed portion 11 of the green filter 16 is provided at a distance from the red filter 15 or the blue filter 17.

Therefore, the width of the color filter 1 above the scan signal line 9 is less than a width d5 of the color filter 1 in the center portion between the adjacent scan signal lines 9. Still further, the width of the color filter 1 above the scan signal line 9 may be the same as the width d2 of the recessed portion 11 along the image signal line 8.

Further, it is preferable that the width d3 of the narrowest portion including the recessed portion 11 of the color filter 1 should be no more than half the width d5 of the color filter 1 in the center portion between the adjacent scan signal lines 9. However, if it is too narrow, the color filter 1 tends to be torn apart in the manufacturing process. Therefore, the narrowest portion should preferably be 20% or more of the width d5 of the color filter 1 in the center portion between the adjacent scan signal lines 9. It is preferable that a recess depth d6 at the bottom of the recessed portion 11 should be a half or more and 80% or less of the width of the color filter 1 in the center portion between the adjacent scan signal lines 9. Here, the recess depth d6 indicates the extent of recess from the edge of the image signal line 8. Further, the width d3 of the narrowest portion of the color filter 1 may be 20% or more and 50% or less of the distance between the adjacent image signal lines 8.

One recessed portion 11 is provided for one subpixel. As shown in FIG. 7, among the plurality of recessed portions 11 arranged along the image signal line 8, some are recessed in one direction along the scan signal line 9, and the others are recessed in the other direction along the scan signal line 9. In this way, the recessed portions 11 may be recessed in different directions.

Further, in a case where the image signal line 8 bends subpixel by subpixel, it is preferable that the direction in which the image signal line 8 bends should coincide with the direction in which the recessed portion 11 is recessed. In FIG. 6, the image signal line 8 bends subpixel by subpixel. Therefore, the recessed portions 11 are recessed in opposite directions alternately from subpixel to subpixel.

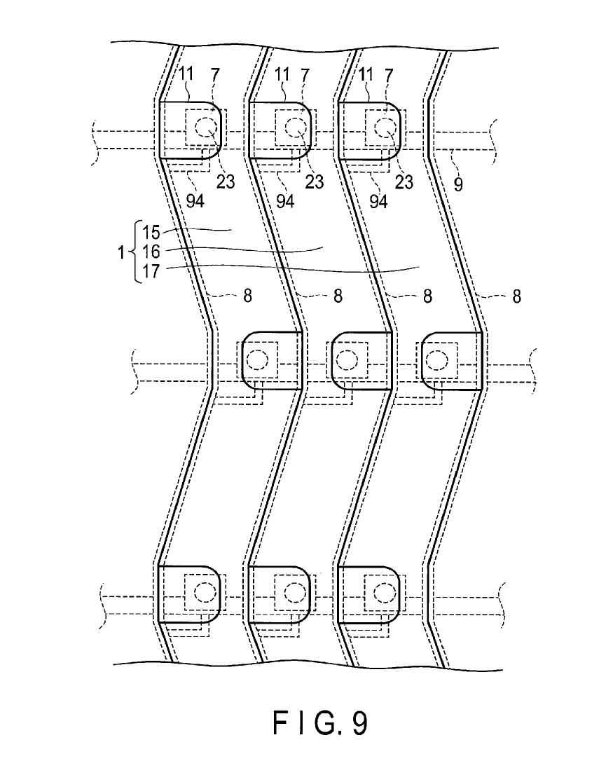

FIG. 9 is a plan view of the thin-film transistor substrate 200 for showing the shape of the color filter 1. Note that, in a case where the image signal line 8 bends subpixel by subpixel, the recessed portion 11 may also be provided at the projecting side of the image signal line 8. The recessed portions 11 are not necessarily recessed in any particular directions and may be recessed in the same direction.

When the recessed portion 11 is provided at the recessed side of the image signal line 8 in planar view, the color filter 1 in the recessed portion 11 has obtuse edges. That is, the recessed portion 11 is formed such that the recessed portion 11 overlaps the projecting portion of the image signal line 8 in planar view. In this structure, as compared to a structure where the color filter 1 in the recessed portion 11 has acute edges, it is possible to prevent a danger of the color filter 1, more specifically, the edges of the color filter 1 in the recessed portion 11 contacting and damaging other members.

The second insulating layer 2 comprises a plate portion 21 and a projecting portion 22. Further, the second insulating layer 2 also comprises a contact hole 23. The second insulating layer 2 is provided above the color filter 1 and is in contact with the color filter 1. The second insulating layer 2 is formed of a transparent insulating material such as an organic positive photoresist. The plate portion 21 has a thickness of 1 to 2 μm.

The plate portion 21 is in a level higher than the color filter 1. The projecting portion 22 projects downward, and is truncated conical and extends along the side surface of the hole of the color filter 1. In the projecting portion 22, the outer side surface is in contact with the inner side surface of the recessed portion 11. The projecting portion 22 extends along the inner side surface of the recessed portion 11 in planar view. Therefore, the second insulating layer 2 is in contact with the color filter 1 and with the periphery of the recessed portion 11.

In the projecting portion 22, the lower edge is in contact with the source electrode V. Further, the projecting portion 22 is in contact with the insulating layer 96. Still further, the space created by the recessed portion 11 between the two adjacent color filters 1 is provided above the image signal line 8. The projecting portion 22 and the color filter 1 are in contact with the same insulating layer 96. Still further, the projecting portion 22 has a flat upper surface. Therefore, layers provided above the projecting portion 22 can be easily flattened.

The contact hole 23 vertically penetrates the projecting portion 22 and is tapered downward. The contact hole 23 has a truncated conical shape, for example, the upper edge of which has a diameter of 4 μm and the lower edge of which has a diameter of 3 μm. The contact hole 23 is provided in the recessed portion 11.

The common electrode 3 is provided above the second insulating layer 2. The common electrode 3 has a plate shape and extends substantially thoroughly across the subpixels. Further, the common electrode 3 may have a strap-like shape extending in the same direction or in the substantially same direction as the pixel electrode 5, which will be described later. The common electrode 3 is formed of a transparent conductive material, for example, indium oxide material such as indium tin oxide (ITO), indium zinc oxide (IZO) or indium gallium oxide (IGO).

The common electrode 3 is connected to the connection terminal 930 via an interconnect and is charged to be at a common voltage. Note that the common voltage may remain constant or may vary with the scan cycle to prevent flicker. The common electrode 3 comprises a hole. The hole of the common electrode 3 is greater than the upper edge of the contact hole 23 formed in the second insulating layer 2. Further, in addition to the hole, the common electrode 3 may further comprise a recessed portion 11 which is recessed in the same direction as the direction in which the recessed portion 11 of the color filter 1 is recessed.

The first insulating layer 4 comprises a flat plate portion 41 and a connection portion 42. The first insulating layer 4 is formed of a transparent insulating material such as silicon nitride.

The flat plate portion 41 is provided above the common electrode 3. The first insulating layer 4 comprises a hole, and the connection portion 42 is provided along the upper surface in the periphery of the hole and partly along the side surface of the hole, and has a substantially truncated conical shape. Note that the first insulating layer 4 may not comprise the connection portion 42.

The connection portion 42 comprises a hole. The hole vertically penetrates the connection portion 42 and is tapered downward. As described above, the projecting portion 22 is in contact with the inner side surface of the recessed portion 11. Therefore, in planar view, the connection portion 42 is provided along a part of the periphery of the contact hole 23. The periphery of the recessed portion 11 is provided on the outside with respect to the lower edge of the connection portion 42.

The pixel electrode 5 is provided for each subpixel and comprises a strap-like portion 51 and a connection portion 52. The pixel electrode 5 is formed of a transparent conductive material, for example, an indium oxide material such as ITO, IZO or IGO, and has a thickness of 100 nm.

The strap-like portion 51 extends along each image signal line 8 and is slightly shorter than the distance between the scan signal lines 9.

The connection portion 52 is integrally formed with the strap-like portion 51. The connection portion 52 is provided along the inner side surface of the connection portion 42 and along the periphery of the hole of the color filter 1, and creates steps. That is, the side surface of the connection portion 52 is provided on the inside of the connection portion 42 of the first insulating layer 4. Further, the side surface of the connection portion 52 of the pixel electrode 5 and the side surface of the hole of the first insulating layer 4 are in contact with each other.

The connection portion 52 projects downward with respect to the connection portion 42 of the first insulating layer 4, and the lower edge of the connecting portion 52 is in contact with the upper surface of the source electrode 7. In this way, the pixel electrode 5 and the source electrode 7 are electrically connected to each other. Therefore, a part of the connection portion 52 is provided on the inside of the recessed portion 11. Further, in planar view, the source electrode 7 is in contact with the connection portion 52 of the pixel electrode 5 on the inside of the recessed portion 11.

Note that the pixel electrode 5 is not necessarily limited to the above-described shape, and may be composed of a plurality of strap-like electrodes arranged side by side with a gap therebetween in each subpixel. Further, at least one of the common electrode 3 and the pixel electrode 5 may be formed in the shape of a plate with a slit. Note that the common electrode 3 and the pixel electrode 5 are not necessarily limited to any particular shapes.

A potential according to an image signal is produced between the pixel electrode 5 and the source electrode 7. A fringe field is produced between the common electrode 3 and the pixel electrode 5 which are electrically connected to each other. The fringe field controls the alignment of the liquid crystal molecules in the liquid crystal layer 400. Further, a portion where the pixel electrode 5, the first insulating layer 4 and the common electrode 3 overlap each other is configured to function as a capacitor, and is thus electrically charged when no voltage is applied thereto.

The first alignment film 97 is provided above the pixel electrode 5 and the first insulating layer 4 where the pixel electrode 5 is not provided. The first alignment film 97 is, for example, polyimide and aligns the liquid crystal molecules of the liquid crystal layer 400 in a specific direction. The first alignment film 97 may be a photoalignment film.

As described above, the contract hole 23 is provided on the inside of the recessed portion 11 formed in the color filter 1, and on the inside of the contact hole 23, the pixel electrode 5, the lower edge of which is in contact with the source electrode 7, and the first alignment film 97, which is in contact with the inner side surface of the pixel electrode 5, are provided.

In planar view, at least a part of the source electrode 7 is provided in the recessed portion 11. Note that, in planar view, the entire source electrode 7 may be provided in the recessed portion 11.

On the inside of the contact hole 23, from the side surface of the hole toward the inner part of the hole, the connection portion 42 of the first insulating layer 4, the connection portion 52 of the pixel electrode 5, which is in contact with the inner side of the connection portion 42, and the first alignment film 97, which is in contact with the inner side of the connection portion 52, are provided. The inner part of the first alignment film 97 is filled with the liquid crystal layer 400. That is, the connection portion 42 of the first insulating layer 4 covers the connection portion 52 of the pixel electrode 5.

The liquid crystal layer 400 includes liquid crystal molecules. The liquid crystal molecules has positive dielectric anisotropy, that is, has stronger dielectric anisotropy in an alignment direction than that of the direction perpendicular to the alignment direction, and shows the nematic phase over a wide range of temperature including room temperature. In this case, the liquid crystal molecules are aligned in a predetermined direction based on the first alignment film 97 and the second alignment film which will be described later, and when no voltage is applied to the liquid crystal layer 400, the liquid crystal molecules are in homogeneous alignment. When the above-described fringe field is produced in the liquid crystal layer 400, the orientations of the respective liquid crystal molecules are laterally rotated.

Further, the liquid crystal molecules in the liquid crystal layer 400 may have negative dielectric anisotropy. In that case, the liquid crystal molecules will have excellent transmittance characteristics.

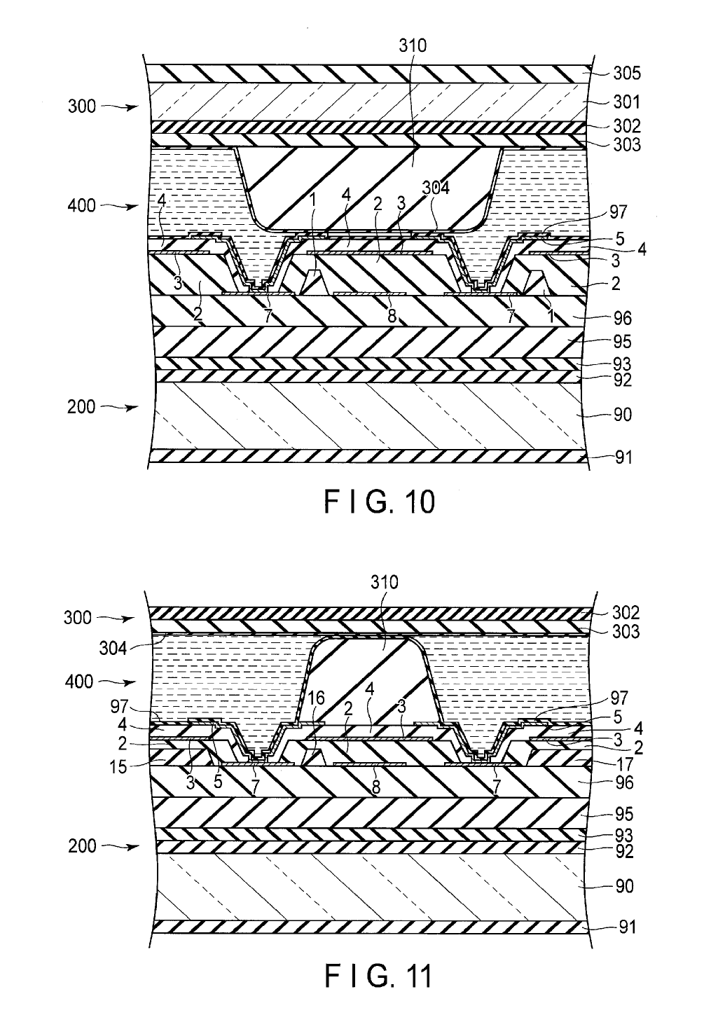

FIG. 10 is a sectional view of the liquid crystal display 100. FIG. 10 is a sectional view along line X-X′ of FIG. 3.

The countersubstrate 300 comprises a transparent substrate 301, a light-blocking layer 302, an overcoat film 303, a second alignment film 304, a second polarizer 305 and a spacer 310.

The transparent substrate 301 has the shape of a flat plate and is formed of a transparent material such as glass or resin. Further, the transparent substrate 301 is, for example, rectangular.

The light-blocking layer 302 is provided below the countersubstrate 300. The light-blocking layer 302 has a strap-like shape. The light-blocking layer 302 has a thickness of 2.0 μm. The light-blocking layer 302 is provided above the scan signal line 9 and is arranged along the scan signal line 9. The light-blocking layer 302 is an organic insulating film and is a black film. Further, the light-blocking layer 302 extends along the scan signal line 9. It is preferable that the light-blocking layer 302 should be wider than the scan signal line 9 and should cover the entire scan signal line 9. Note that the light-blocking layer 302 may be provided above the image signal line 8 and be arranged along the image signal line 8. The light-blocking layer 302 overlaps the recessed portion 11 in planar view, and should preferably overlap the entire recessed portion 11.

The overcoat film 303 is provided below the light-blocking layer 302 and the transparent substrate 301 where the light-blocking layer 302 is not provided. The overcoat film 303 is in contact with the light-blocking layer 302 and with the transparent substrate 301. The overcoat film 303 is formed of an insulating material such as polyimide or epoxy.

The second alignment film 304 is provided below the overcoat film 303. The second alignment film 304 is in contact with the overcoat film 303. The first alignment film 97 is, for example, polyimide and aligns the liquid crystal molecules of the liquid crystal layer 400 in a specific direction. The second alignment film 304 may be a photoalignment film.

The second polarizer 305 is provided above the transparent substrate 301. The second polarizer 305 is in contact with the transparent substrate 301. The absorption axis of the second polarizer 305 and the absorption axis of the first polarizer 91 are orthogonal to each other in planar view.

The spacer 310 is provided at the intersection of the image signal line 8 and the scan signal line 9 in planar view. The spacer 310 is formed of a photosensitive insulating material such as acrylic resin. The photosensitive insulating material should preferably be a negative resist. Further, in addition to the insulating member, the spacer 310 further comprises the second alignment film 304 provided on the top of the insulating member. Note that the spacer 310 may not necessarily comprise the second alignment film 304 on the top of the spacer 310.

The spacer 310 projects downward from the light-blocking layer 302 or from the overcoat film 303 and is in contact with the thin-film transistor substrate 200. The second alignment film 304 is provided on the outer surface of the spacer 301. The second alignment film 304 may not be provided at the lower edge of the spacer 310, and the spacer 310 may be directly in contact with the thin-film transistor substrate 200.

FIG. 11 is a sectional view of the liquid crystal display 100. FIG. 11 is a sectional view corresponding to the sectional view of FIG. 10 along line X-X′ of FIG. 3. Note that, as shown in FIG. 11, the spacer 310 may be provided on the thin-film transistor substrate 200, may project upward, and may be in contact with the countersubstrate 300.

The spacer 310 is provided in the recessed portion 11 in planer view. The spacer 310 is partly or entirely provided on the inside of the recessed portion 11. In this structure, the space created between the two adjacent color filters 1 is provided below the spacer 310. Further, at least a part of the spacer 310 is provided above the projecting portion 22.

In general, as a structure for arranging two different color filters, to prevent a space between the color filters, a display device has such a structure where one color filter is overlaid on the other color filter. However, since the overlapping portion has a thickness of two color filters, the upper surface of the substrate in the overlapping portion rises. For this reason, it is difficult to have a flat surface in the overlapping portion and in the vicinity of the overlapping portion.

In the liquid crystal display device 100 of the present embodiment, since the connection portion 52 of the pixel electrode 5 is provided in the recessed portion 11 in planar view, the two adjacent color filters 1 will not overlap each other in the recessed portion 11. In the meantime, the second insulating layer 2 can adjust the thickness of the color filter 1 and flatten the upper surface of the color filter 1 relatively easily. Therefore, it is possible to obtain a flat surface in the recessed portion 11 more easily by the first insulating layer 4. In this way, a uniform gap can be easily maintained between the thin-film transistor substrate 200 and the countersubstrate 300, and thus a uniform thickness of the liquid crystal layer 400 can be easily maintained. Therefore, the display characteristics of the liquid crystal display device 100 improve.

Further, according to the liquid crystal display device 100 of the present embodiment, two adjacent color filters 1 can be prevented from overlapping each other. In the meantime, to realize a high-definition liquid crystal display device 100, each pixel should preferably have a larger color display area. According to the liquid crystal display device 100 of the present embodiment, adjacent color filters 1 overlap each other in the portion other than the recessed portion 11, and thus the color display area can be increased. In this way, the display characteristics of the liquid crystal display device 100 improve.

Still further, a conventional color filter has a hole in a portion corresponding to a contact hole for contacting an electrode. However, a color filter having a recessed portion 11 can be manufactured more easily than the conventional color filter having a hole because the recessed portion 11 is partly open. Therefore, the liquid crystal display device 100 of the present embodiment can be easily manufactured.

Still further, the projection portion 22 has a flat upper surface. Therefore, layers above the projection portion 22 can be more easily flattened. When the layers above the projection portion 22 are flat, a uniform gap area where a uniform gap is maintained between the thin-film transistor substrate 200 and the countersubstrate 300 can be increased. Therefore, according to the liquid crystal display device 100 of the present embodiment, it is possible to increase the contact area of the spacer 310 with the thin-film transistor substrate 200 and thereby reduce the number of the spacers 310.

### Second Embodiment

The second embodiment will be described. In a liquid crystal display device 100 of the present embodiment, a color filter 1 comprises a projecting portion 12. In the present embodiment, description of structures the same as those of the above-described embodiment will be omitted.

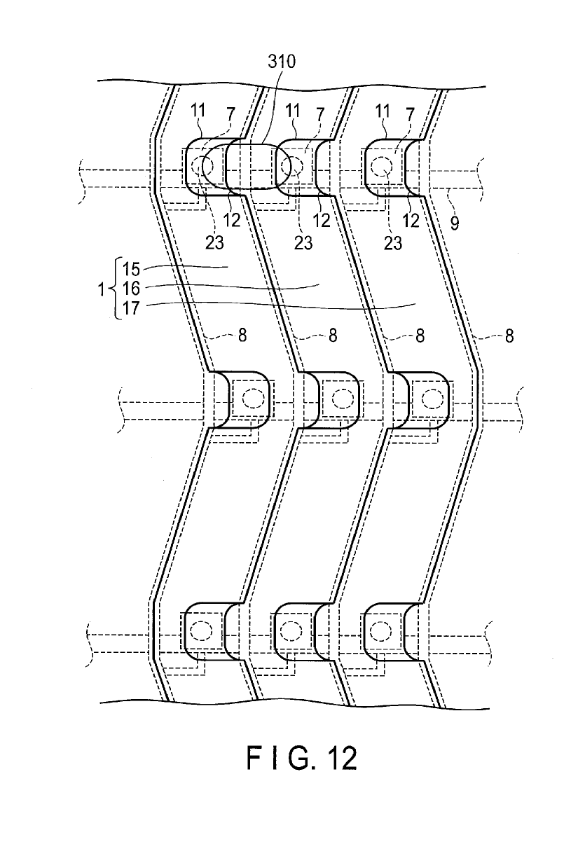

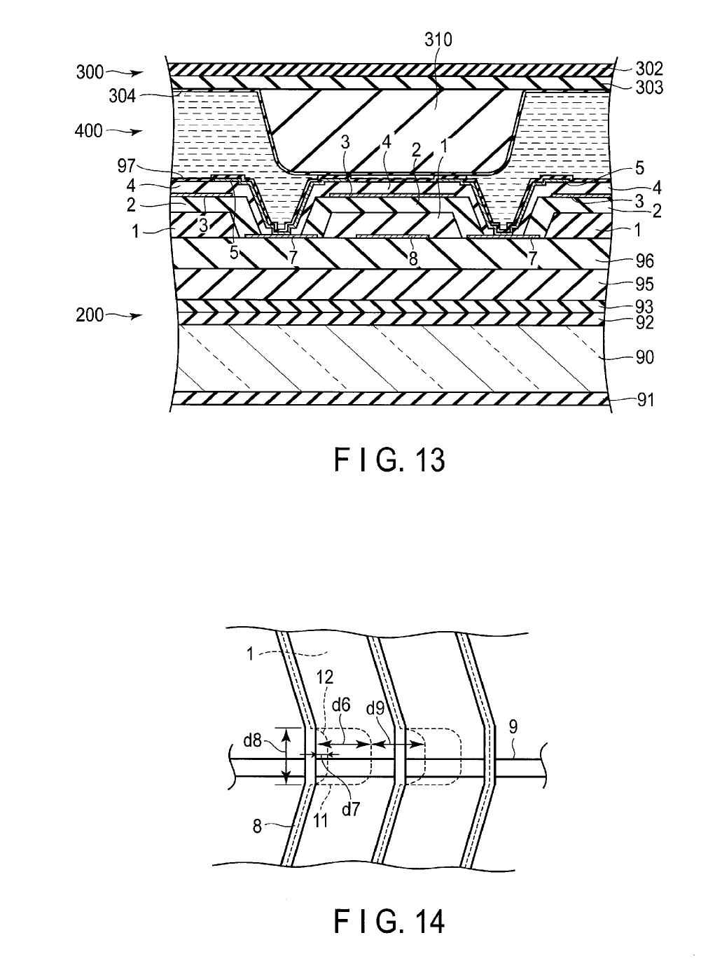

FIG. 12 is a plan view of a thin-film transistor substrate 200 for showing the shape of the color filter 1. FIG. 13 is a sectional view of the liquid crystal display device 100. FIG. 13 corresponds to the sectional view of FIG. 10 along line X-X′ of FIG. 3. The projecting portion 12 is provided on the side of the color filter 1 opposite to the side of a recessed portion 11. The projecting portion 12 projects in the same direction as the direction in which the recessed portion 11 is recessed.

FIG. 14 is a plan view of the thin-film transistor substrate 200 for explaining dimensions. A projection depth d7 of the top of the projection portion 12 should preferably be 10% or more, more desirably, 20% or more of the width of the color filter 1 in a center portion between adjacent scan signal lines 9. In that case, as in the case of a recess depth d6, the projection depth d7 indicates the extent of projection from the edge of the overlapping image signal line 8. On the other hand, to prevent the projection portion 12 from overlapping a connection portion 52 or the like, the projection depth d7 should preferably be 50% or less of the width of the color filter 1 in the center portion between the adjacent scan signal lines 9.

Note that the projection depth d7 may be 10 to 50% or 20 to 50% of the distance between the adjacent image signal lines 8.

A width d8 of the projection portion 12 along the image signal line 8 is less than a width 2 of the recessed portion 11 along the image signal line 8. The width d8 of the projection portion 12 along the image signal line 8 should preferably be 70% or more of the width d2 of the recessed portion 11 along the image signal line 8.

In the liquid crystal display device 100 of the present embodiment also, the width of the color filter 1 above the scan signal line 9 is less than a width d5 of the color filer 1 in the center portion between the adjacent scan signal lines 9. Further, a width d9 of a narrowest portion of the color filter 1 including the recessed portion 11 along the scan signal line 9 should preferably be 70% or less of the width of the color filter 1 in the center portion between the adjacent scan signal lines 9. The width of the narrowest portion of the color filter 1 should preferably be a half or more of the width of the color filter 1 in the center portion between the adjacent scan signal lines 9.

The projecting portion 12 is provided in the vicinity of the intersection of the scan signal line 9 and the image signal line 8. Therefore, according to the liquid crystal display device 100 of the present embodiment, the thin-film transistor substrate 200 at the intersection can be easily flattened. Further, the projecting portion 12 may be provided above the projecting portion 22.

Still further, a contact hole 23 may be provided between the recessed portion 11 and the projecting portion 12. Therefore, it is possible to provide the recessed portion 11 and the projecting portion 12 without causing an undesirable effect on electrical connection such as connection between a thin-film transistor 99 and a pixel electrode 5.

Since the liquid crystal display device 100 of the present embodiment comprises the color filter 1 including the recessed portion 11 and the projecting portion 12, it is possible to increase the strength of color filter 1 in the vicinity of the recessed portion 11. Therefore, the liquid crystal display device 100 can appropriately prevent such a situation where the color filter 1 is torn apart in the vicinity of the recessed portion 11.

Further, since the liquid crystal display device 100 of the present embodiment comprises the color filter 1 including the recessed portion 11 and the projecting portion 12, a flat surface area can be increased in the vicinity of the intersection of the scan signal line 9 and the image signal line 8. Therefore, it is possible to increase the contact area of a spacer 310 with the thin-film transistor substrate 200 and thereby reduce the number of the spacers 310.

### Third Embodiment

The third embodiment will be described. A liquid crystal display device 100 of the present embodiment is different from that of the second embodiment in the arrangement of the color filter 1 and the second insulating layer 2.

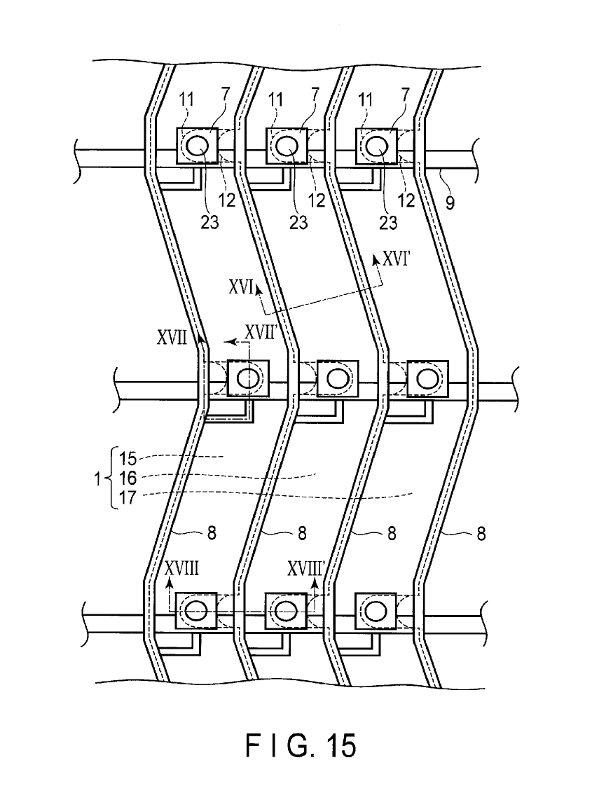

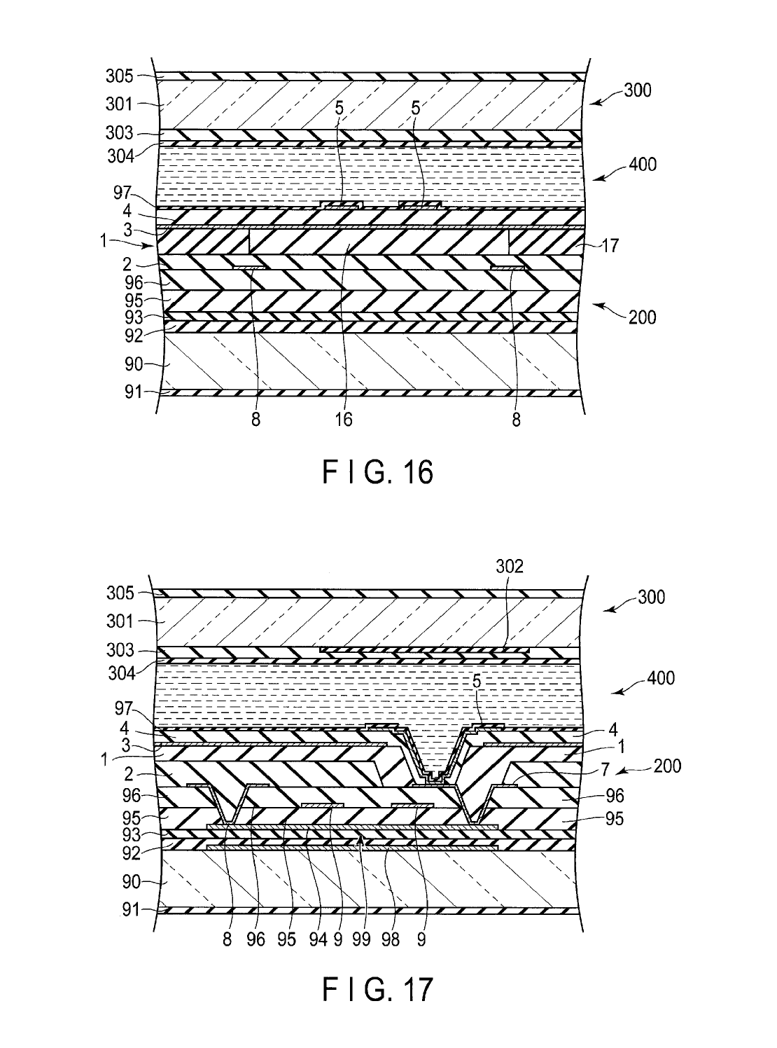

FIG. 15 is a plan view of the liquid crystal display device 100. FIG. 16 is a sectional view of the liquid crystal display device 100. FIG. 17 is a sectional view of the liquid crystal display device 100. FIG. 16 is a sectional view along line XVI-XVI′ of FIG. 15. FIG. 17 is a sectional view along line XVII-XVII′ of FIG. 15.

In an area other than the periphery of a contact hole 23, a color filter 1 is provided in a level higher than a second insulating layer 2. Further, on the side closer to the contact hole 23, a recessed portion 11 and a projecting portion 12 project downward. That is, the contact hole 23 and a connection portion 42 are provided in the recessed portion 11 which projects downward. Note that the projecting portion 12 is not necessarily an essential element but should preferably be formed in the liquid crystal display device 100 of the present embodiment.

A projecting portion 22 of the second insulating layer 2 projects downward.

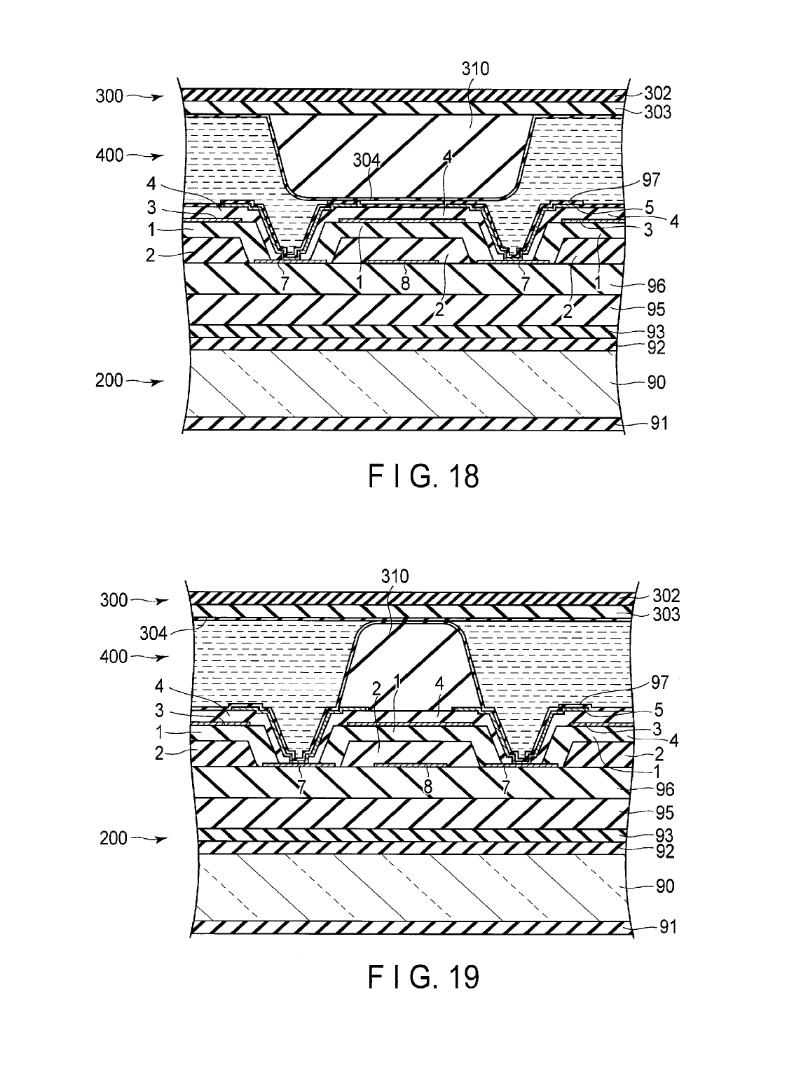

FIG. 18 is a sectional view of the liquid crystal display device 100. FIG. 19 is a sectional view of the liquid crystal display device 100. FIG. 18 is a sectional view along line XVIII-XVIII′ of FIG. 15. FIG. 19 corresponds to the sectional view of FIG. 18 along line XVIII-XVIII′ of FIG. 15. A spacer 310 may be provided on either one of a thin-film transistor substrate 200 and a countersubstrate 300.

In the present embodiment, the projecting portion 22 and the recessed portion 11 are in contact with a source electrode 7. Further, the projecting portion 22 and the recessed portion 11 may be in contact with the same layer such as an insulating layer 96 or the like.

As compared to the case of the first embodiment, the recessed portion 11 can be provided more closely with the contact hole 23. The periphery of the recessed portion 11 has a partial arc shape, the upper edge of which has a diameter of 6 μm and the lower edge of which has a diameter of 4 μm. Therefore, according to the liquid crystal display device 100 of the present embodiment, it is possible to reduce the size of the recessed portion 11 as compared to that of the first embodiment. Consequently, according to the liquid crystal display device 100, it is possible to reduce the size of a light-blocking layer 302 and thereby improve an aperture ratio.

In the liquid crystal display device 100 of the present embodiment, since the color filter 1 is close to a liquid crystal layer 400, color mixing can be more appropriately prevented.

### Fourth Embodiment

The fourth embodiment will be described. As compared to the first embodiment, a liquid crystal display device 100 of the present embodiment does not comprise a second insulating layer 2.

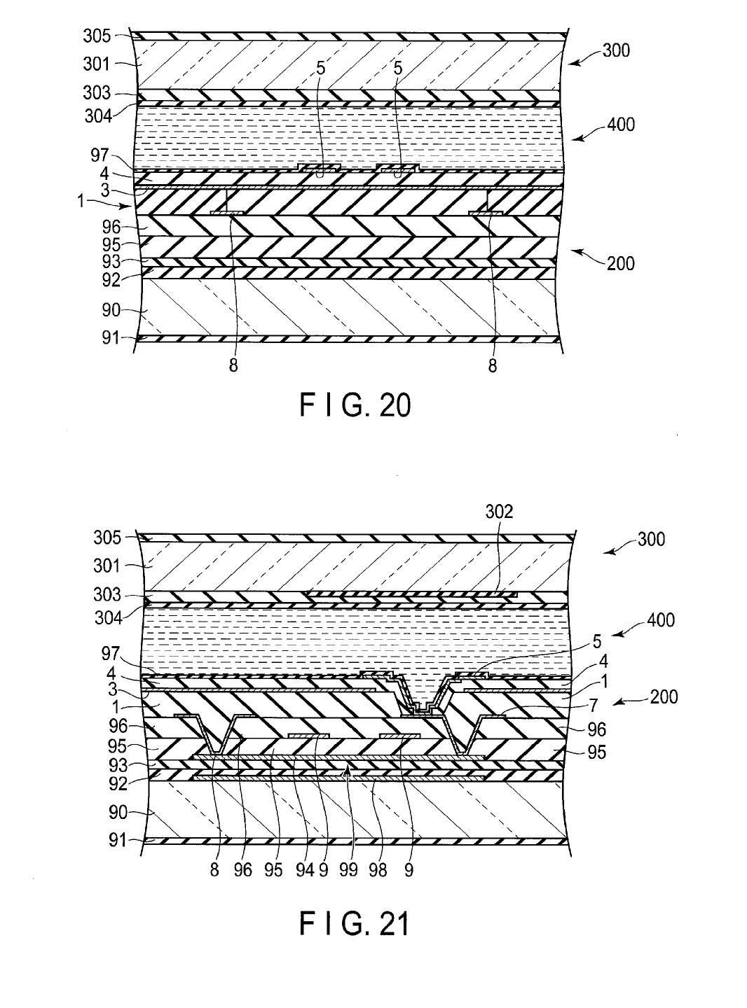

FIG. 20 is a sectional view of the liquid crystal display device 100. FIG. 21 is a sectional view of the liquid crystal display device 100. FIG. 20 corresponds to the sectional view of FIG. 16 along line XVI-XVI′ of FIG. 15. FIG. 21 corresponds to the sectional view of FIG. 17 along XVII-XVII′ of FIG. 15.

The upper surface of a color filter 1 is in contact with a pixel electrode 5. The upper surface of the color filter 1 should preferably be in the same height as the upper surface of the second insulating layer 2. On the other hand, the lower surface of the color filter 1 is in contact with an insulating layer 96, an image signal line 8 and a source electrode 7.

A first insulating layer 4 is provided on the inside of a recessed portion 11. Further, the inner side surface of the recessed portion 11 and the outer side surface of the first insulating layer 4 are in contact with each other.

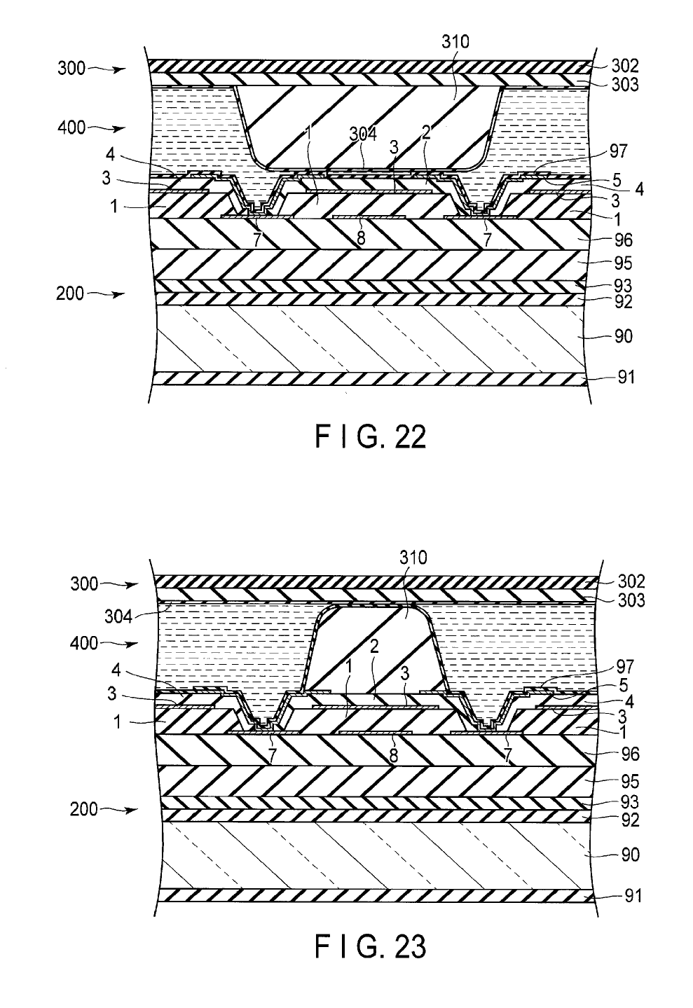

FIG. 22 is a sectional view of the liquid crystal display device 100. FIG. 23 is a sectional view of the liquid crystal display device 100. FIG. 22 corresponds to the sectional view of FIG. 18 along line XVIII-XVIII′ of FIG. 15. FIG. 23 corresponds to the sectional view of FIG. 18 along line XVIII-XVIII′ of FIG. 15.

The color filter 1 of the present embodiment should preferably comprise the recessed portion 11 and a projecting portion 12.

In the liquid crystal display device 100 of the present embodiment, since the color filter 1 has one surface contacting the pixel electrode 5 and the other surface contacting the image signal line 8 and the source electrode 7, the thickness of a thin-film transistor substrate 200 can be reduced.

### Fifth Embodiment

The fifth embodiment will be described. A liquid crystal display device 100 of the present embodiment is different from that of the first embodiment in the arrangement of the pixel electrode 50 and the common electrode 3.

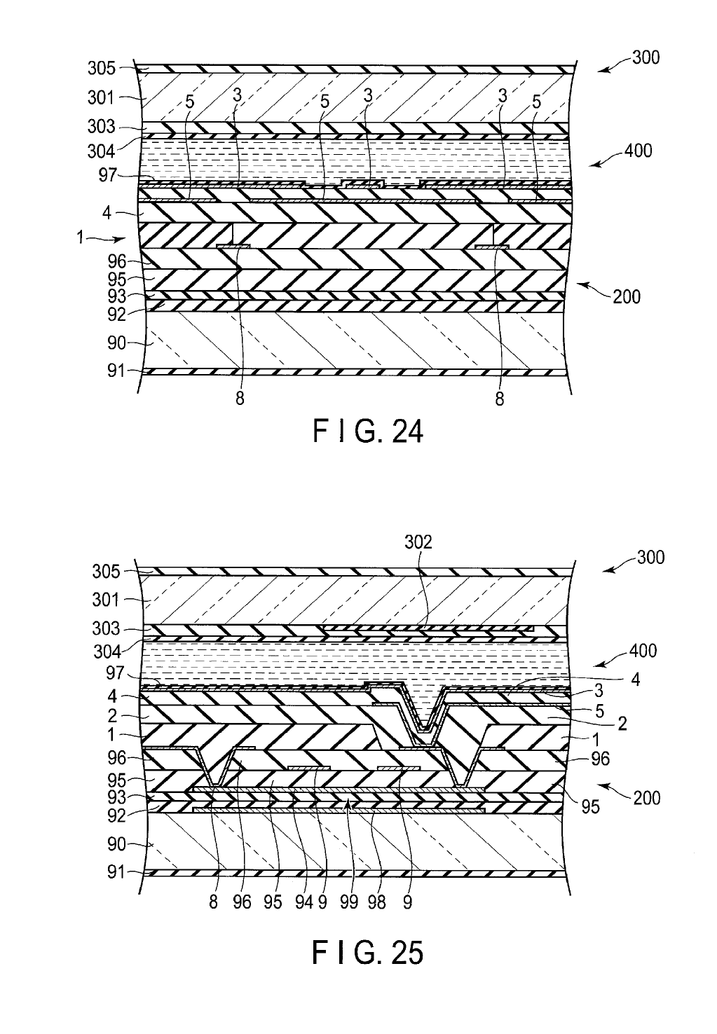

FIG. 24 is a sectional view of the liquid crystal display 100. FIG. 25 is a sectional view of the liquid crystal display 100. FIG. 24 corresponds to the sectional view of FIG. 4 along line IV-IV′ of FIG. 3. FIG. 25 corresponds to the sectional view of FIG. 5 along line V-V′ of FIG. 3.

In the liquid crystal display device 100 of the present embodiment, a pixel electrode 5 is provided below a first insulating layer 4, and a common electrode 3 is provided above the first insulating layer 4. Further, the common electrode 3 comprises a connection portion 32 projecting downward. Therefore, the common electrode 3 is formed such that the distance to a connection portion 52 of the pixel electrode 5 will not be considerably different from the distance to a strap-like portion 51 of the pixel electrode 5. In planar view, the common electrode 3 comprises a strap-like portion, and the pixel electrode 5 has the shape of a flat plate. Note that the common electrode 3 may have the shape of a flat plate and the pixel electrode 5 may comprise a strap-like portion. At least one of the common electrode 3 and the pixel electrode 5 may be formed in the shape of a plate with a slit. Note that the common electrode 3 and the pixel electrode 5 are not limited to any particular planar shapes.

The connection portion 32 and the connection portion 52 may not project downward, but for example, the upper surface of the connection portion 32 may be leveled with the portion of the common electrode 3 other than the connection portion 32. The upper surface of the connection portion 52 may be leveled with the portion of the pixel electrode 5 other than the connection portion 52. In that case, for example, a source electrode 7 may project down to the upper surface of the second insulating layer 2. The connection portion 32 and the source electrode 7 may be integrally formed with each other.

Further, in addition to the modifications of the second embodiment and the third embodiment, the present embodiment also includes a liquid crystal display device 100 comprising a color filter 1 provided in a level higher than a first insulating layer 4.

In the case of providing the color filter 1 in a level higher than the first insulating layer 4, the shape of the color filter 1 is not limited to the above-described shape but may be formed in any shape as long as the first insulating layer 4 comprises a recessed portion 11. Further, the color filter 1 should preferably comprise a projecting portion 12.

### Sixth Embodiment

The sixth embodiment will be described. A liquid crystal display device 100 of the present embodiment is different from that of the fifth embodiment in the arrangement of the common electrode 3.

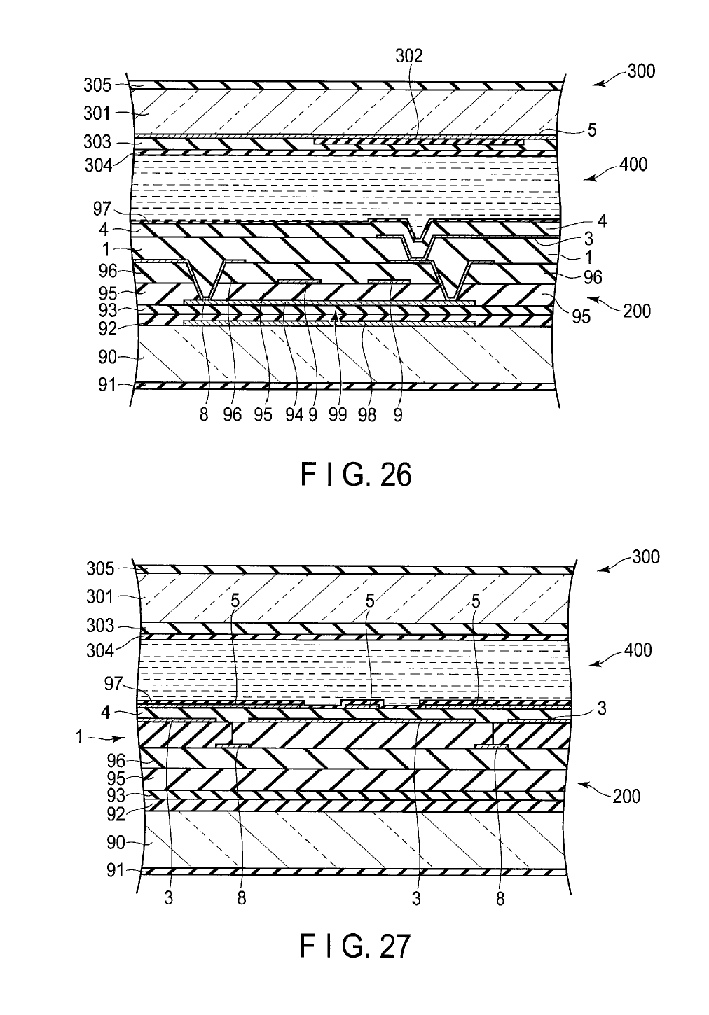

FIG. 26 is a sectional view of the liquid crystal display device 100. FIG. 26 corresponds to the sectional view of FIG. 5 along line V-V′ of FIG. 3. The liquid crystal display device 100 may be a display device conforming to a twisted nematic (TN) mode, an optically compensated bend (OCB) mode, or a vertical alignment (VA) mode. In this case, a common electrode 3 is provided on a countersubstrate 300. Further, a first alignment film 97 and a second alignment film 304 are subjected to an alignment treatment such that the liquid crystal molecules of a liquid crystal layer 400 are perpendicularly rotated.

### Seventh Embodiment

The seventh embodiment will be described. A liquid crystal display device 100 of the present embodiment is different from that of the fourth embodiment in the arrangement of the pixel electrode 5 and the common electrode 3.

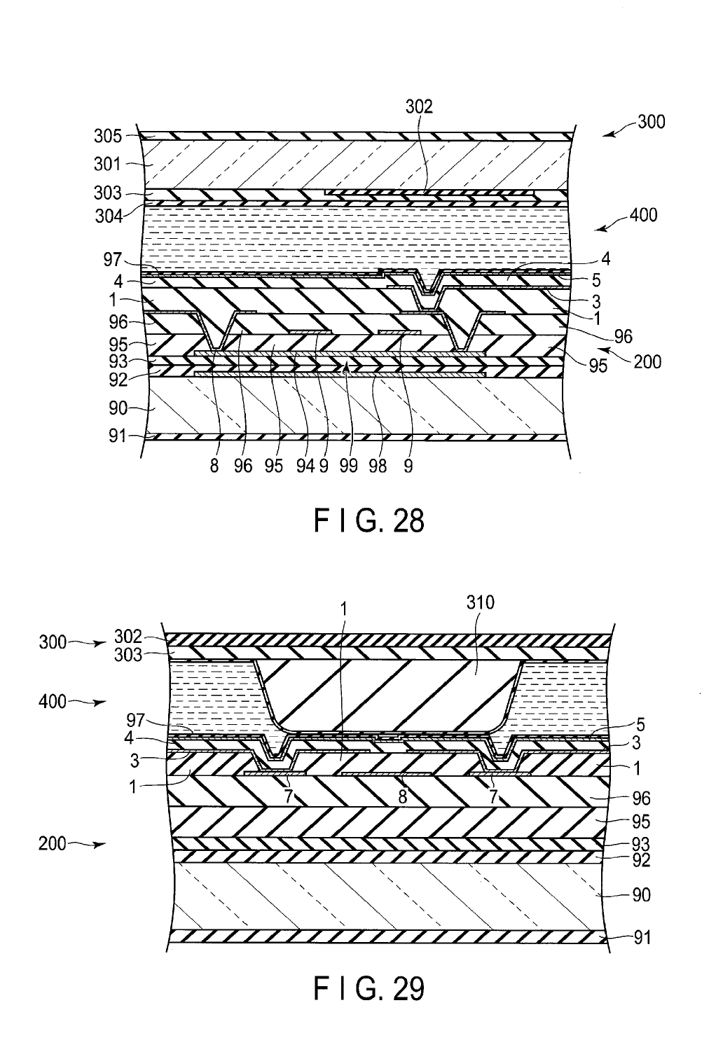

FIG. 27 is a sectional view of the liquid crystal display device 100. FIG. 28 is a sectional view of the liquid crystal display device 100. FIG. 29 is a sectional view of the liquid crystal display device 100. FIG. 27 corresponds to the sectional view of FIG. 4 along line IV-IV′ of FIG. 3. FIG. 28 corresponds to the sectional view of FIG. 5 along line V-V′ of FIG. 3. FIG. 29 corresponds to the sectional view of FIG. 10 along line X-X′ of FIG. 3.

A color filter 1 is provided below a second insulating layer 2 and is in contact with the second insulating layer 2.

In planar view, a spacer 310 is provided between connection portions 32 of two adjacent subpixels.

According to the liquid crystal display device 100 of the present embodiment, the surface at the intersection of an image signal line 8 and a scan signal line 9 can be easily flattened, and thus the end surface of the spacer 310 can be easily flattened.

### Eighth Embodiment

The eighth embodiment will be described. A liquid crystal display device 100 of the present embodiment comprises a common line 210.

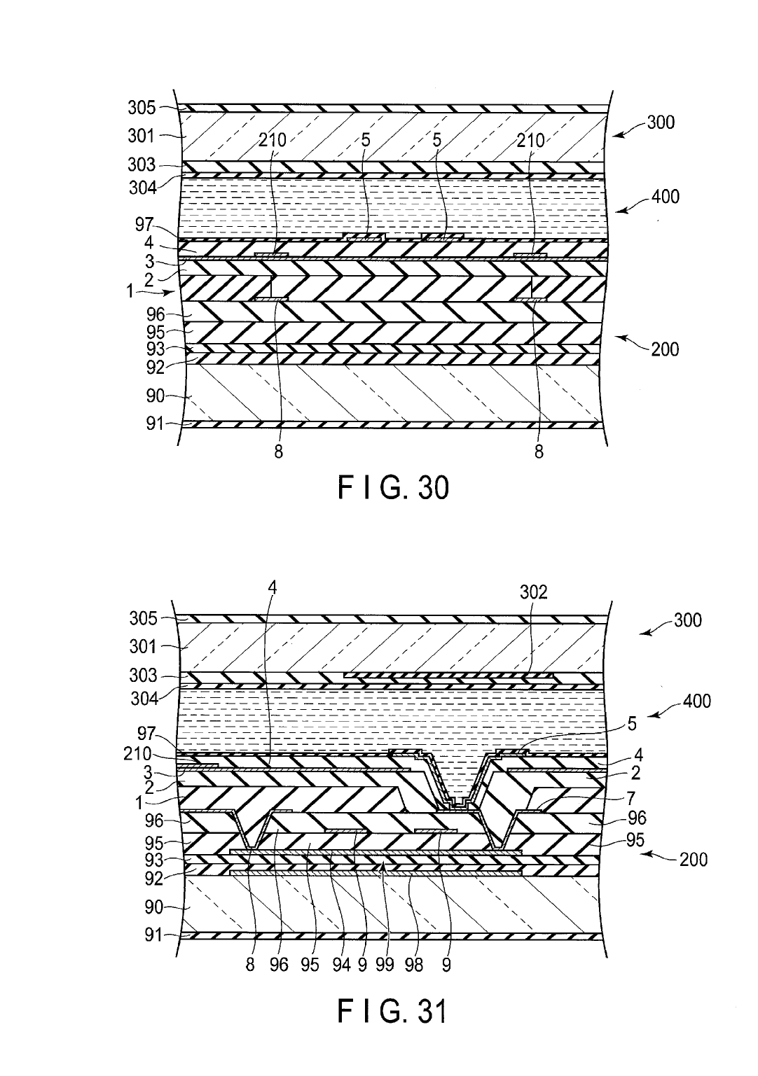

FIG. 30 is a sectional view of the liquid crystal display device 100. FIG. 31 is a sectional view of the liquid crystal display device 100. FIG. 30 corresponds to the sectional view of FIG. 4 along line IV-IV′ of FIG. 3. FIG. 31 corresponds to the sectional view of FIG. 5 along line V-V′ of FIG. 3.

The common line 210 is provided above an image signal line 8. More specifically, the common line 210 extends along the image signal line 8 and overlaps the image signal line 8 in planar view. The common electrode 210 is provided above a common electrode 3. The common line 210 is electrically connected to the common electrode 3, and is preferably provided above the common electrode 3. The common line 210 is, for example, a chromium molybdenum alloy. Note that the common line 210 may be any material having lower resistance than the common electrode 3 and may be, for example, an aluminum silicon alloy.

The common line 210 is provided along the image signal line 8. It is preferable that the common line 210 extending along the image signal line 8 is wider than the image signal line 8 and overlaps the entire image signal line 8 in planar view. In a thin-film transistor substrate 200, a portion where the common line 210 is provided rises by the thickness of the common line 210. Therefore, the portion at the intersection of the image signal line 8 and a scan signal line 9 tends to rise, accordingly. Note that the common line 210 may be provided along the scan signal line 9.

In the liquid crystal display device 100 of the present embodiment, a first insulating layer 4 is provided at the intersection of the common line 210 extending along the image signal line 8 and the scan signal line 9 and entirely laterally across these signal lines in the vicinity of the intersection. Further, the first insulating layer 4 is provided in the recessed portion of the color filter 1. Therefore, according to the liquid crystal display device 100 of the present embodiment, the intersection of the common line 210 and the scan signal line 9 can be easily flattened by the first insulating layer 4. Further, the liquid crystal display device 100 of the present embodiment can prevent two adjacent color filters 1 from overlapping each other.

### Ninth Embodiment

The ninth embodiment will be described. A liquid crystal display device 100 of the present embodiment is different from that of the first embodiment in that the thin-film transistor substrate 200 and the countersubstrate 300 respectively comprise spacers.

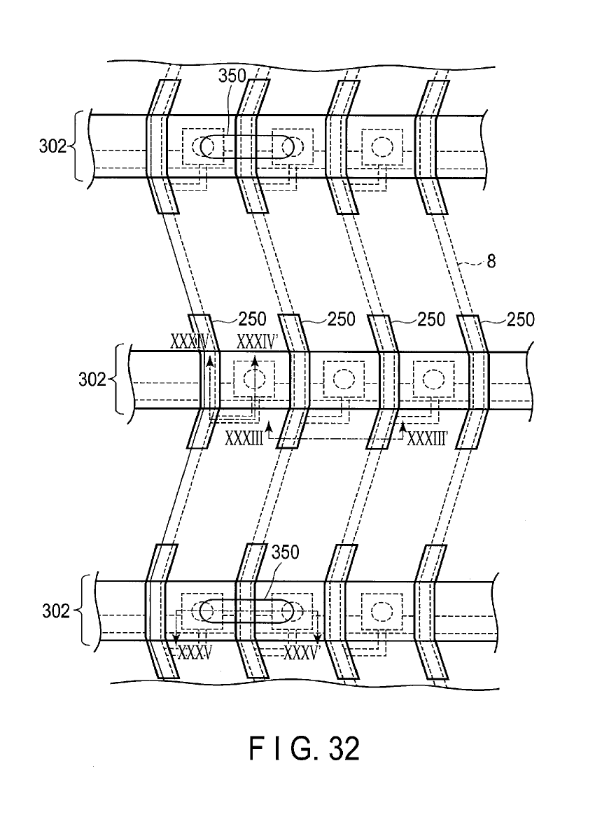

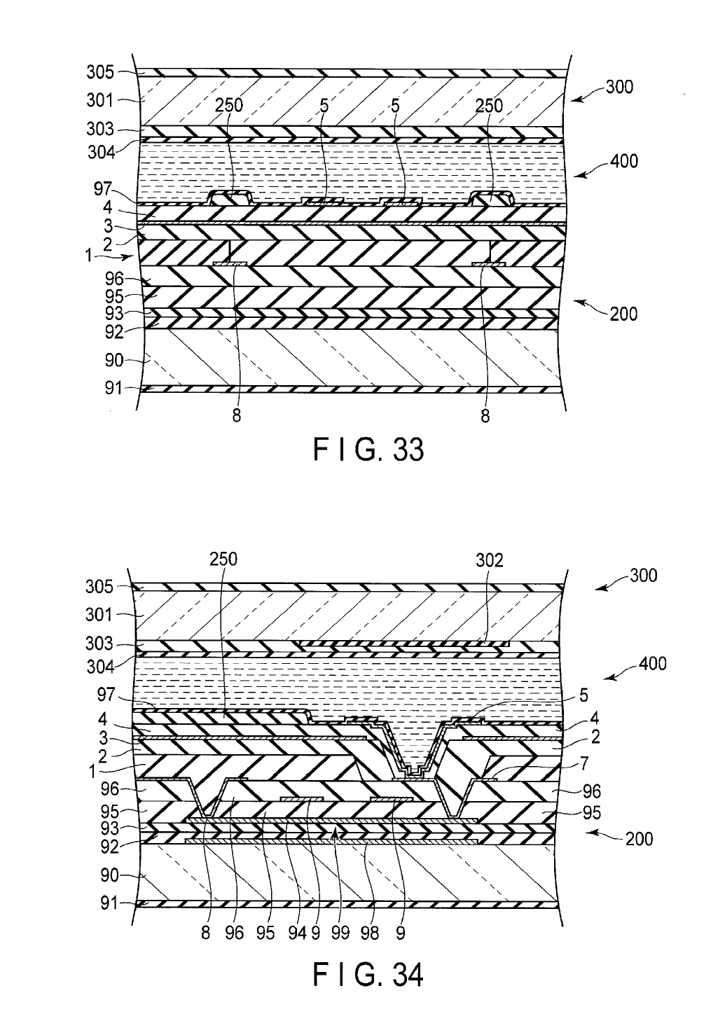

FIG. 32 is a plan view of the liquid crystal display 100 for showing the positions of a first spacer 250 and a second spacer 350. FIG. 33 is a sectional view of the liquid crystal display device 100. FIG. 34 is a sectional view of the liquid crystal display device 100. FIG. 33 is a sectional view along line XXXIII-XXXIII′ of FIG. 32. FIG. 34 is a sectional view along line XXXIV-XXXIV′ of FIG. 32.

A thin-film transistor substrate 200 comprises the first spacer 250. The first spacer 250 is provided along an image signal line 8 in planar view. The first spacer 250 has a height of 0.7 μm and is, for example, a negative resist.

In particular, at the intersection of the image signal line 8 and a scan signal line 9, the first spacer 250 should preferably have a uniform thickness but may have a variable thickness as long as the first spacer 250 has a uniform thickness difference or a thickness difference of 20% or less of the average thickness within this area.

A countersubstrate 300 comprises the second spacer 350. The second spacer 350 is ellipsoidal along the scan signal line 9 in planar view. The second spacer 350 has a height of 2.5 μm and is, for example, a positive resist.

The second spacer 350 is provided in a position including the intersection of the image signal line 8 and the scan signal line 9. It is preferable that the second spacer 350 entirely overlaps a light-blocking layer 302 provided along the scan signal line 9. In planar view, the second spacer 350 has, for example, a long ellipsoidal shape and extends along the scan signal line 9.

It is preferable that the first spacer 250 should have a larger flat upper surface and the second spacer 350 should have a larger flat lower surface, and that the first spacer 250 and the second spacer 350 should have trapezoidal sections.

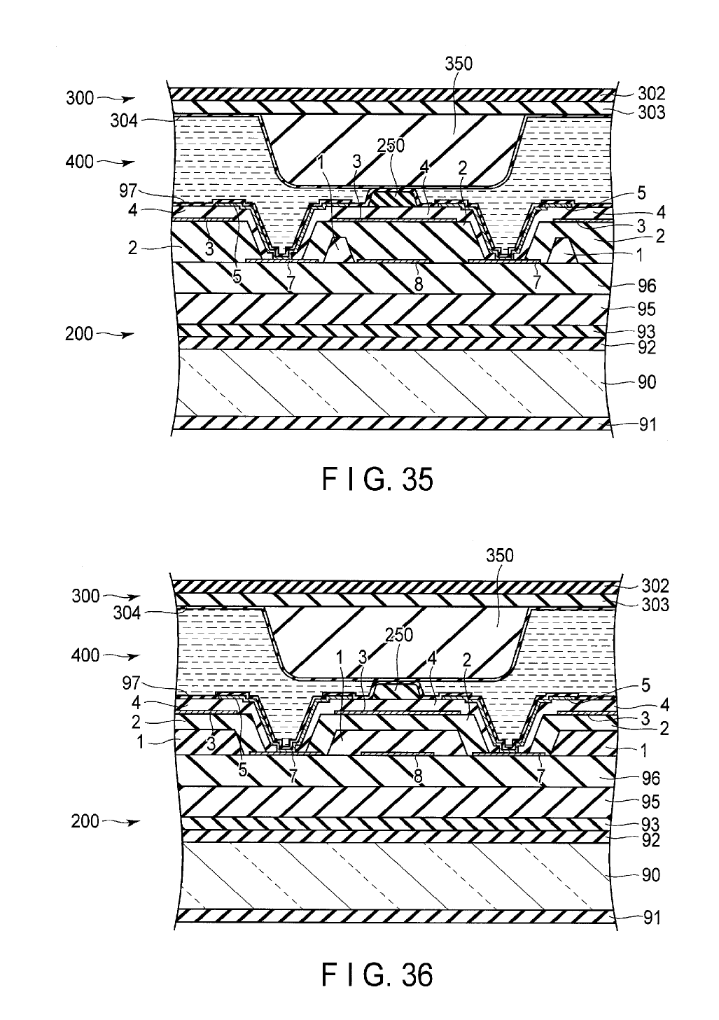

FIG. 35 is a sectional view of the liquid crystal display device 100. FIG. 35 is a sectional view along line XXXV-XXXV′ of FIG. 32.

The top surface of the first spacer 250 and the top surface of the second spacer 350 are in contact with each other. The first spacer 250 includes a portion extending along the image signal line 8 in planar view, and the second spacer 350 extends along the scan signal line 9 in planar view. Therefore, the first spacer 250 and the second spacer 350 contact each other at the intersection of the image signal line 8 and the scan signal line 9 in planar view.

The thin-film transistor substrate 200 comprises the first spacer 250, the countersubstrate 300 comprises the second spacer 350 including a contact surface which is in contact with the first spacer 250, and the contact surface is provided on the inside of the recessed portion in planar view.

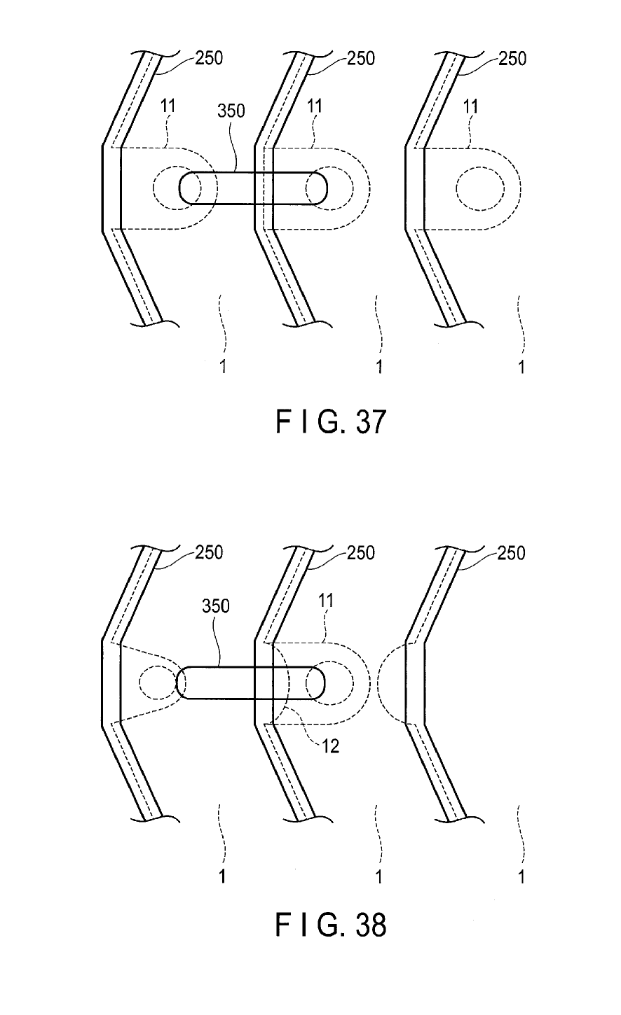

FIG. 36 is a sectional view of the liquid crystal display device 100. FIG. 36 corresponds to the sectional view of FIG. 35 along line XXXV-XXXV′ of FIG. 32. FIG. 37 is a plan view of the liquid crystal display device 100 for showing the positions of a color filter 1, the first spacer 250 and the second spacer 350. In planar view, the periphery of a recessed portion 11 is provided on the outside of the second spacer 350.

FIG. 38 is a plan view of the liquid crystal display device 100 for showing the positions of the color filter 1, the first spacer 250 and the second spacer 350. As in the case of the second embodiment, the color filter 1 may comprises a projecting portion 12. In that case, the projecting portion 12 will be provided above a portion where the first spacer 250 and the second spacer 350 overlap each other in planar view.

In the liquid crystal display device 100 of the present embodiment, the contact surface where the first spacer 250 and the second spacer 350 are in contact with each other is provided in the recessed portion 11, and thus the portion where the spacers are in contact with each other can be easily flattened.

### Tenth Embodiment

The tenth embodiment will be described. A liquid crystal display device 100 of the present embodiment is different from the ninth embodiment in the shape of the first spacer 250.

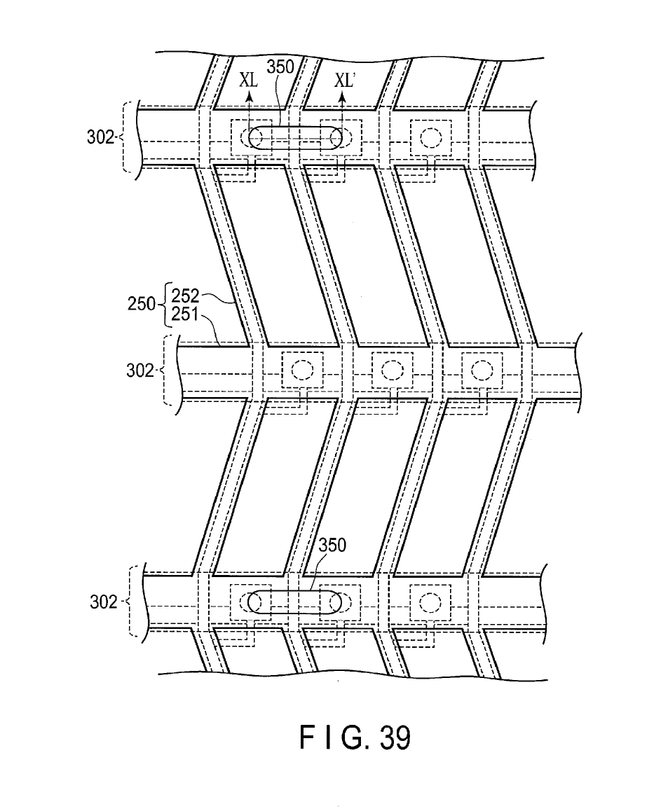

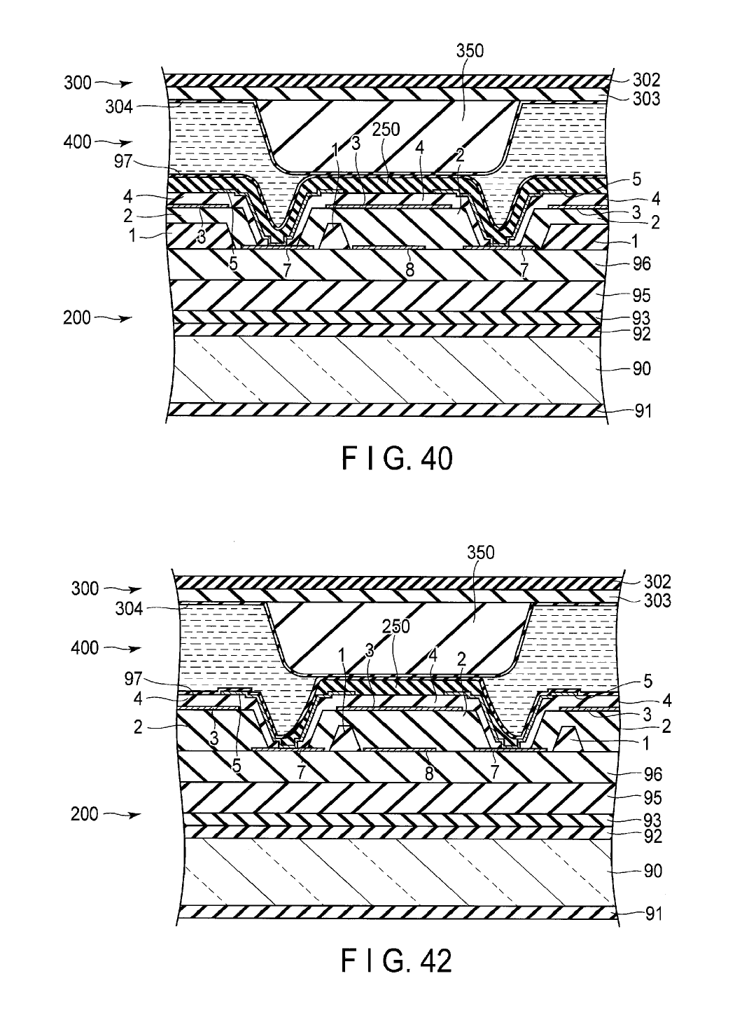

FIG. 39 is a plan view of the liquid crystal display device 100 for showing the positions of a first spacer 250 and a second spacer 350. FIG. 40 is a sectional view of the liquid crystal display device 100. FIG. 40 is a sectional view along line XL-XL′ FIG. 39.

A thin-film transistor substrate 200 comprises the first spacer 250. The first spacer 250 comprises a lattice of a first strap-like portion 251 and a second strap-like portion 252 in planar view. The first spacer 250 has a height of 0.7 μm and is, for example, a negative resist.

The second strap-like portion 252 extends along an image signal line 8. The second strap-like portion 252 should preferably be provided above the entire image signal line 8 provided between at least two adjacent scan signal lines 9. The first strap-like portion 251 extends along the scan signal line 9. It is preferable that the first strap-like portion 251 should be provided above the entire scan signal line 9 extending across the plurality of image signal lines 8.

The second strap-like portion 252 is provided along the boundary of adjacent subpixels arranged side by side along the scan signal line 9. Further, the second strap-like portion 252 is continuously provided across the plurality of scan signal lines 9. The second strap-like portion 252 is wider than the overlapping image signal line 8 in planar view.

The first strap-like portion 251 should preferably have a uniform thickness within an area from the point directly above one edge of the scan signal line 9 to the point directly above the other edge of the scan signal line 9 laterally relative to the scan signal line 9, but may have a variable thickness as long as the first strap-like portion 251 has a uniform thickness difference or a thickness difference of 20% or less of the average thickness within this area. The first strap-like portion 251 is wider than the overlapping the scan signal line 9 in planar view.

In particular, at the intersection of the image signal line 8 and the scan signal line 9, the first strap-like portion 251 should preferably have a uniform thickness but may have a variable thickness as long as the first strap-like portion 251 has a uniform thickness difference or a thickness difference of 20% or less of the average thickness within this area.

Further, the first spacer 250 is provided in the contact hole 23 and above the connection portion 52. The first spacer 250 is provided in a level higher than a common electrode 3 and a pixel electrode 5. The first spacer 250 should preferably be provided thoroughly on the inner side of the contact hole 23 and above the connection portion 52. That is, the first spacer 250 may be provided above the contact hole 23, and the periphery of the first spacer 250 may be provided at a distance from the contact hole 23 in planar view.

Since the first spacer 250 has a variable thickness in the periphery, the upper surface in the periphery cannot be easily flattened. However, in the liquid crystal display device 100 of the present embodiment, the first spacer 250 is provided in the contact hole 23, and thus a uniform height area where the first spacer 250 has a uniform height can be increased between two contact holes 23. Therefore, a flat upper surface area where the first spacer 250 has a flat upper surface can be increased.

The countersubstrate 300 comprises the second spacer 350. The second spacer 350 has a long ellipsoidal shape and extends along the scan signal line 9 in planar view. The second spacer 350 has a height of 2.5 μm and is, for example, a positive resist.

The second spacer 350 is provided in a position including the intersection of the image signal line 8 and the scan signal line 9. It is preferable that the second spacer 350 entirely overlaps a light-blocking layer 302 provided along the scan signal line 9. In planar view, the second spacer 350 has, for example, a long ellipsoidal shape and extends along the scan signal line 9.

It is preferable that the first spacer 250 should have a larger flat upper surface and the second spacer 350 should have a larger flat lower surface, and that the first spacer 250 and the second spacer 350 should have trapezoidal sections.

The top surface of the first spacer 250 and the top surface of the second spacer 350 are in contact with each other. The first spacer 250 includes a portion extending along the image signal line 8 in planar view, and the second spacer 350 extends along the scan signal line 9 in planar view. Therefore, the first spacer 250 and the second spacer 350 are in contact with each other at the intersection of the image signal line 8 and the scan signal line 9 in planar view.

Since the first spacer 250 comprises the first strap-like portion 251, in a portion where the first space 250 and the second spacer 350 overlap each other, the width along the scan signal line 9 is greater than the width along the image signal line 8.

A color filter 1 of the present embodiment may extend along the image signal line 8 and may have less projections and recesses than the image signal line 8. Further, the color filter 1 may be provided on the countersubstrate 300.

The color filter 1 of the present embodiment should preferably comprise the recessed portion 11 as in the case of the first embodiment. In that case, the periphery of the second spacer 350 should preferably be provided on the inside of the recessed portion 11 in planar view.

Since the color filter 1 comprises the recessed portion 11, even if two adjacent color filters 1 are provided closely to each other, the color filters 1 will not overlap each other in the vicinity of the recessed portion 11. Therefore, above the recessed portion 11, the upper surface of the thin-film transistor substrate 200 can be easily flattened. The first spacer 250 of the present embodiment has a large top surface. Therefore, as the first spacer 250 has a larger flat lower surface, the first spacer 250 has a larger contact surface which is in contact with the second spacer 350, accordingly. Further, it is preferably that the thin-film transistor substrate 200 of the present embodiment should comprise the second spacer 350 including a contact surface which is in contact with the first spacer 250, and that the contact surface should be provided in the recessed portion in planar view.

Generally, in a conventional liquid crystal layer, liquid crystal molecules are tend to be aligned based on the shape of the ends of spacers. Therefore, it is difficult to control the liquid crystal molecules even by a fringe field in the vicinity of the ends of the spacers. Therefore, in the case of a conventional spacer comprising ends in a pixel, in particular, even if a conventional liquid crystal display executes dark display control in a display area by blocking incident light from a backlight, the incident light may still be transmitted.

In the liquid crystal display device 100 of the present embodiment, the first spacer 250 comprises the first strap-like portions 251 integrally formed with each other and provided continuously above the plurality of scan signal lines 9. In this structure, the ends of the first spacer 250 are not provided above the plurality of the scan signal lines 9. Therefore, light leakage in the dark display can be suppressed. Consequently, the display characteristics of the liquid crystal display device 100 improve. Further, the display characteristics the liquid crystal display device 100 of the present embodiment especially improves when the liquid crystal display device 100 comprises a narrower light-blocking member along the image signal line 8 or when the liquid crystal display device 100 does not comprises any light-blocking member.

According to the liquid crystal display device 100 of the present embodiment comprising the color filter 1 including the first spacer 250, the second spacer 350 and the recessed portion 11, the top surface can be easily flattened. Consequently, the contact area of the first spacer 250 and the second spacer 350 can be increased, and thus the number of the second spacers 350 can be reduced.

### Eleventh Embodiment

The eleventh embodiment will be described. In a liquid crystal display device 100 of the present embodiment, a first spacer 250 is selectively provided.

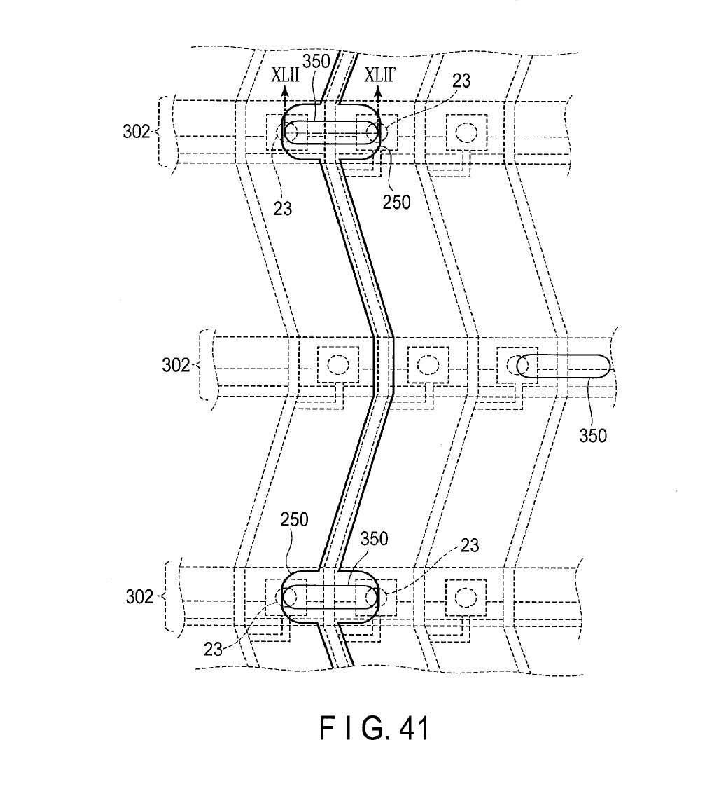

FIG. 41 is a plan view of the liquid crystal display device 100 for showing the positions of the first spacer 250 and a second spacer 350. FIG. 42 is a sectional view of the liquid crystal display device 100. FIG. 42 is a sectional view along line XLII-XLII′ of FIG. 41.

The first spacer 250 is continuously provided above some of a plurality of image signal lines 8. Further, the first spacer 250 is provided on the inside of a contact hole 23 and above a part of a connection portion 52. That is, the periphery of the first spacer 250 is provided in the contact hole 23 and above the connection portion 52.

The first spacer 250 may be provided thoroughly on the inside of the contact hole 23 and above the connection portion 52. That is, the first spacer 250 may be provided above the contact hole 23, and the periphery of the first spacer 250 may be provided at a distance from the contact hole 23 in planar view. In that case, the first spacer 250 overlaps one image signal line 8 in planar view but is provided at a distance from the other image signal lines 8. Further, it is preferable that the entire periphery of the second spacer 250 is provided on the outside of the entire periphery of the second spacer 350. The first spacer 250 comprises a projecting portion which projects along the scan signal line 9, and at least a part of the projecting portion is in contact with the second spacer 350.

In this way, the first spacer 250 can have a larger flat upper surface. In the meantime, above the other image signal lines 8, a first alignment film 97 and a first insulating layer 4 are in contact with each other. For example, the first spacer 250 is provided only above an image signal line 8 in a position where the second spacer 350 is provided.

According to the liquid crystal display device 100 of the present embodiment, since the first spacer 250 is selectively provided, the manufacturing process can be simplified. Further, the liquid crystal display device 100 of the present embodiment contributes to weight reduction as well as manufacturing cost reduction.

Note that embodiments described above are merely examples in all aspects and are in no way restrictive. The scope of the invention should not be interpreted as described above but should be interpreted as recited in the claims, and should also include various modifications as long as the modifications come within the scope of a claimed invention and an invention substantially equivalent to the claimed invention. Further, the technical features of the embodiments can be combined with each other, and new technical features can be produced from the combination of the technical features of the embodiments. For example, the combination of the technical concept of any one of the first to eighth embodiments and the technical concept of any one of the ninth to eleventh embodiments also comes within the technical concept of the present invention.

What is claimed is:

1. A liquid crystal display device comprising:
a first substrate including a scan signal line, an image signal line, a thin-film transistor, and a color filter including a recessed portion which is recessed in planar view;
a second substrate above the first substrate;
a liquid crystal layer between the first substrate and the second substrate; and
a spacer, wherein
the spacer and the scan signal line are provided in the recessed portion in planar view.

2. The liquid crystal display of claim 1, wherein the color filter is continuously provided above the three or more scan signal lines.

3. The liquid crystal display of claim 1, wherein
the first substrate comprises a first electrode electrically connected to the thin-film transistor,
one of the first substrate and the second substrate comprises a second electrode which produces an electric field with the first electrode, and
the first electrode and the thin-film transistor are in contact with each other in the recessed portion in planar view.

4. The liquid crystal display device of claim 1, comprising the plurality of color filters, wherein
one part of the periphery of one color filter including the recessed portion is provided at a distance from the other color filter, and
the other part of the periphery of the one color filter overlaps the other color filter.

5. The liquid crystal display device of claim 1, wherein
the image signal line meanders, and
a direction in which the image signal line bends coincides with a direction in which the recessed portion is recessed.

6. The liquid crystal display device of claim 1, wherein
the image signal line meanders, and
a direction in which the image signal line bends is opposite to a direction in which the recessed portion is recessed.

7. The liquid crystal display device of claim 1, wherein the color filter includes a projecting portion on the side opposite to the side of the recessed portion.

8. The liquid crystal display device of claim 7, wherein the spacer is provide above the projecting portion.

9. The liquid crystal display device of claim 1, wherein
the spacer includes a first spacer provided on the first substrate and a second spacer provided on the second substrate and having a contact surface which is in contact with the first spacer, and
the contact surface is provided in the recessed portion in planar view.

10. The liquid crystal display device of claim 9, wherein the first spacer is continuously provided above the plurality of scan signal lines.

11. A liquid crystal display device comprising:
a first substrate comprising a scan signal line, an image signal line, a thin-film transistor, and a color filter including a recessed portion which is recessed in planar view;
a second substrate above the first substrate;
a liquid crystal layer between the first substrate and the second substrate; and
a spacer, wherein
an intersection of the scan signal line and the image signal line is provided in the recessed portion in planar view.

12. The liquid crystal display device of claim 11, wherein the color filter is continuously provided above the three or more scan signal lines.

13. The liquid crystal display device of claim 11, wherein
the first substrate includes a first electrode electrically connected to the thin-film transistor,
one of the first substrate and the second substrate includes a second electrode which produces an electric field with the first electrode, and
the first electrode and the thin-film transistor are in contact with each other in the recessed portion in planar view.

14. The liquid crystal display device of claim 11, comprising the plurality of color filters, wherein
one part of the periphery of one color filter including the recessed portion is provided at a distance from the other color filter, and
the other part of the periphery of the one color filter overlaps the other color filter.

15. The liquid crystal display device of claim 11, wherein
the image signal line meanders, and
a direction in which the image signal line bends coincides with a direction in which the recessed portion is recessed.

16. The liquid crystal display device of claim 11, wherein
the image signal line meanders, and
a direction in which the image signal line bends is opposite to a direction in which the recessed portion is recessed.

17. The liquid crystal display device of claim 11, wherein the color filter includes a projecting portion on the side opposite to the side of the recessed portion.

18. The liquid crystal display device of claim 11, wherein
the spacer includes a first spacer provided on the first substrate, and a second spacer provided on the second substrate and having a contact surface which is in contact with the first spacer, and
the contact surface is provided in the recessed portion in planar view.

19. The liquid crystal display device of claim 11, wherein the spacer overlaps the intersection in planar view.

20. A liquid crystal display device comprising:
a first substrate including a scan signal line, an image signal line, a thin-film transistor, a plurality of color filters;
a second substrate above the first substrate;
a liquid crystal layer between the first substrate and the second substrate; and
a spacer, wherein
some of the color filters are narrower than the others of the color filters, and
the narrower color filters are provided along the scan signal lines.
